(19) United States
(12) Patent Application Publication
(10) Pub. No.: US 2017/0268247 A1
(43) Pub. Date: Sep. 21, 2017

(54) Enclosing Apparatus for Contained Aerial Vehicle Flight and Associated Systems, Methods, and Computer Program Products

(71) Applicant: Drone Parks Worldwide LLC, The Woodlands, TX (US)

(72) Inventor: Nicholas Aaron Madincea, The Woodlands, TX (US)

(73) Assignee: Drone Parks Worldwide LLC, The Woodlands, TX (US)

(21) Appl. No.: 15/070,250

(22) Filed: Mar. 15, 2016

(51) Int. Cl. E04H 3/10; G06Q 30/06; B64D 47/08; B64D 43/02; B64C 39/02; G05D 1/00

(52) U.S. Cl. CPC E04H 3/10; B64C 39/024; G05D 1/0011; B64D 47/08; B64D 43/02; G06Q 30/0645

(57) ABSTRACT

Enclosing apparatus and associated systems, methods, and computer program products capable of limiting aerial vehicle flight to within an at least partially enclosed area are disclosed. In an aspect, enclosing apparatus and associated systems, methods, and computer program products are disclosed that comprise at least one flight zone in which aerial vehicles may be flown, as well as at least one user area in which users may control, observe, and/or analyze aerial vehicles within the fight zone, receive aerial vehicle flight training, and get feedback information on aerial vehicle performance, amongst other things. Such enclosing apparatus and associated systems, methods, and computer program products may serve to facilitate aerial vehicle flight, particularly unmanned aerial vehicle flight, within an at least partially controlled environment. The disclosed enclosing apparatus and associated systems, methods, and computer program products may also be used with one or more electronic communication networks to facilitate a variety of activities including aerial vehicle rentals and/or aerial vehicle competitions and/or games.

### FIELD OF THE DISCLOSURE

The present disclosure generally relates to enclosing apparatus and associated systems, methods, and computer program products and more particularly to enclosing apparatus configured to accommodate the flight of at least one aerial vehicle, as well as associated systems, methods, and computer program products for facilitating activities related to aerial vehicle flight.

### BACKGROUND

The statements in this section merely provide background information related to the present disclosure and may not constitute prior art.

In recent years, aerial vehicle usage has increased, particularly with regard to the recreational use of unmanned aerial vehicles, often referred to as “drones.” Simultaneously, security and privacy issues associated with such recreational drone usage have become more prevalent. For example, casual drone flyers are oftentimes either unfamiliar and/or indifferent towards laws regarding restricted airspace as well as social norms regarding the privacy expected in areas proximal to personal property. This disregard has led to many incidents of drone pilots receiving complaints and citations due to flying their drones in inappropriate and/or illegal areas.

In addition to security and privacy concerns, drones that are flown in inappropriate areas pose the risk of causing damage to property, including houses, cars, and other aircraft. This is particularly true amongst novice drone users, who may lose control of their devices or underestimate the risk associated with flying their machines too close to other objects. Additionally, people may be injured by erratic drone flight, and airspace becomes increasingly congested as more and more people purchase and fly drones, thereby increasing the risk of collisions between drones and other aircraft. p

In an effort to curtail some of the problems associated with increased drone usage, the Federal Aviation Administration has started imposing a registration requirement for some drone types before the drones may be flown outdoors. While the registration process provides a chance to teach drone pilots about safe flying practices as well as the rules associated with drone flight, drone flyers still assume a considerable amount of risk when exposing their aircraft to exposed outdoor environments, where buildings, trees, animals, and even other drones represent potential sources of impact and resulting damage, and inclement weather may threaten to disturb and/or damage drones during flight.

In an effort to preempt the possible occurrence of drone damage due to outdoor flight, some drone pilots resort to flying their machines in common indoor spaces, such as atriums and large rooms. While this may be appealing to some, it is still not ideal in that most indoor spaces are fraught with hard edges, corners, and other structures that may seriously damage a drone upon impact. This risk is exasperated when pilots engage in drone racing as well as other flying based competitions or games.

Even when a suitable flying environment is available, many would-be drone pilots forgo the enjoyment of drone use due to the cost of drone ownership. Many drone models cost well over one hundred dollars, with prices for some models reaching tens of thousands of dollars. This is a significant deterrent to users who may only want to occasionally engage in drone piloting.

Given the foregoing, enclosing apparatus and associated systems, methods, and computer program products are needed that allow users to fly aerial vehicles, such as drones, within an at least partially-contained environment substantially free of security, privacy, safety, and property damage risks associated with aerial vehicle flight. Further, enclosing apparatus and associated systems, methods, and computer program products that minimize the possibility of aerial vehicle damage are needed. Enclosing apparatus and associated systems, methods, and computer program products that facilitate flight-based aerial vehicle competitions or games are also desired, as are enclosing apparatus and associated systems, methods, and computer program products that increase the availability of aerial vehicles to users in a cost-effective way.

### SUMMARY

This Summary is provided to introduce a selection of concepts. These concepts are further described below in the Detailed Description section. This summary is not intended to identify key features or essential features of this disclosure's subject matter, nor is this Summary intended as an aid in determining the scope of the disclosed subject matter.

Aspects of the present disclosure meet the above-identified needs by providing enclosing apparatus and associated systems, methods, and computer program products that facilitate aerial vehicle flight within an at least partially contained amount of airspace. Specifically, in an aspect, enclosing apparatus and associated systems, methods, and computer program products are disclosed that may comprise at least one flight zone capable of providing enough airspace to accommodate the flight path of at least one aerial vehicle. The flight zone may be configured such that aerial vehicles flown within the flight zone are prevented from leaving the flight zone by at least one physical barrier, such as netting material, durable cloth or canvas, rubber padding, and the like, and/or at least one electronic barrier. The at least one physical barrier, as well as the interior portion of the flight zone, generally, may be designed such that aerial vehicles flown within the flight zone are not exposed to any hard corners, edges, or surfaces that may impose damage to the vehicles upon impact.

In some instances, the flight zone may comprise at least one open entryway through which aerial vehicles may enter and exit the flight zone. In some aspects, each entryway may be parabolic in shape and be of sufficient size so as to allow the desired type of aerial vehicle(s) to pass through it. Multiple entryways may be configured adjacent to one another, such as in a side-by-side or stacked configuration.

In some aspects, the at least one physical barrier of the flight zone of the present disclosure may be securely attached to a durable support frame structure. In some instances, the support structure may comprise metal piping welded together so as to provide a cylindrical configuration designed to suspend the at least one physical barrier in a dome-like or parabolic shape in which aerial vehicles may be flown. In some additional aspects, the support structure may comprise any number of freestanding pillars and support arms configured to suspend the at least one physical barrier.

In some additional aspects, enclosing apparatus and associated systems, methods, and computer program products in accordance with the present disclosure may comprise at least one user area in which pilots for unmanned aerial vehicles, or drones, flown within the flight zone may safely control their machines. The user area may be a protected area within the flight zone itself, an enclosed or open space attached to an external portion of the flight zone, or an enclosed or open space separate from the flight zone. In any case, the user area may allow drone users to visibly monitor their machines by direct visual observation and/or by electronically assisted viewing, such as video display screens streaming live camera feeds from within the flight zone and/or from a location upon one or more aerial vehicles. Within the user area, users may receive training regarding proper drone flight, as well as real-time and/or past performance information regarding their drone usage, such as average speed, agility ratings, competition/game scores, and the like. Such information may come from visual observers and/or various cameras, sensors, and/or computing devices that may be configured within the flight zone and/or upon one or more aerial vehicles.

In still some additional aspects, systems, methods, and computer program products associated with the enclosing apparatus of the present disclosure may be configured to facilitate aerial vehicle competitions/games, rentals, sales, and/or consultations via electronic communication over one or more networks. This may allow aerial vehicle pilots to engage in aerial vehicle competitions/games, rentals, sales, and/or consultations from remote locations, thereby increasing aerial vehicle availability and convenience of use, as well as lowering the cost associated with aerial vehicle usage.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a cutaway side view of an exemplary enclosing apparatus for contained aerial vehicle flight, according to an aspect of the present disclosure.

FIG. 2 is a top view of an exemplary enclosing apparatus for contained aerial vehicle flight, according to an aspect of the present disclosure.

FIG. 3 is a perspective view of an exemplary support structure for an enclosing apparatus for contained aerial vehicle flight, according to an aspect of the present disclosure.

FIG. 4 is a cutaway side view of an exemplary containment boundary for an enclosing apparatus for contained aerial vehicle flight, according to an aspect of the present disclosure.

FIG. 5 is a cutaway side view of an exemplary user area for an enclosing apparatus for contained aerial vehicle flight, according to an aspect of the present disclosure.

FIG. 6 is a cutaway side view of a second exemplary enclosing apparatus for contained aerial vehicle flight, according to an aspect of the present disclosure.

FIG. 7 is a block diagram of an exemplary system for facilitating electronic communication of information between different components associated with an exemplary enclosing apparatus, according to an aspect of the present disclosure.

FIG. 8 is a flowchart illustrating an exemplary process for electronically obtaining at least temporary control of an aerial vehicle via one or more networks, according to an aspect of the present disclosure.

FIG. 9 is a flowchart illustrating an exemplary process for participating in an aerial vehicle competition or game via one or more networks, according to an aspect of the present disclosure.

FIG. 10 is a flowchart illustrating an exemplary process for creating an aerial vehicle competition or game to be engaged in via one or more networks, according to an aspect of the present disclosure.

FIG. 11 is a flowchart illustrating an exemplary process for electronically purchasing and taking control of an aerial vehicle via one or more networks, according to an aspect of the present disclosure.

FIG. 12 is a flowchart illustrating an exemplary process for electronically selling and surrendering control of an aerial vehicle via one or more networks, according to an aspect of the present disclosure.

FIG. 13 is a flowchart illustrating an exemplary process for engaging in an electronic consultation regarding at least one aerial vehicle via one or more networks, according to an aspect of the present disclosure.

FIG. 14 is a dataflow diagram of an exemplary communication process for an exemplary system for facilitating electronic communication of information between different components associated with an exemplary enclosing apparatus, according to an aspect of the present disclosure.

FIG. 15 is a block diagram of an exemplary computing system useful for implementing one or more aspects of the present disclosure.

### DETAILED DESCRIPTION

The present disclosure is directed to enclosing apparatus and associated systems, methods, and computer program products that provide an at least partially contained environment in which the flight path of one or more aerial vehicles may be limited. Aspects of the present disclosure provide enclosing apparatus and associated systems, methods, and computer program products that include at least one area for flying aerial vehicles, or flight zone, and at least one additional area, the user area, wherein users may control, observe, and/or analyze aerial vehicles, particularly those that may be unmanned. Specifically, in an aspect, enclosing apparatus and associated systems, methods, and computer program products are disclosed that include at least one flight zone wherein aerial vehicles may be flown with minimal risk of damage to the vehicles themselves or to other objects, people, and/or property, as well as at least one user area configured to provide a pleasurable experience to pilots of such aerial vehicles when those vehicles are unmanned, in addition to other users. Enclosing apparatus and associated systems, methods, and computer program products that facilitate the ability of users to engage in aerial vehicle competitions/games, aerial vehicle rentals, aerial vehicle sales, and aerial vehicle consultations via one or more networks are also disclosed.

The term “enclosing apparatus” and/or the plural form of this term are used throughout herein to refer to any apparatus that uses material(s), structure(s), and/or any other boundary-defining object(s), including electrical-based boundary-defining components, to define an at least partially contained area configured to keep objects, people, and/or animals from moving from an area outside of the apparatus to an area within the apparatus, and vice versa, such boundary-defining objects and/or components comprising netting material, canvas, cloth, ropes, metals, plastics, wood, concrete, cables, cords, glass, other polymers, electric fencing components, electric signals and/or impulses, various forms of wireless communications media, and the like, as well as any combination thereof.

The term “aerial vehicle” and/or the plural form of this term are used throughout herein to refer to any vehicle, machine, or device capable of flight within Earth's atmosphere and/or in an extraterrestrial environment, such as unmanned aerial vehicles (also referred to as “drones”), airplanes, helicopters, spacecraft, and the like, any of which may be powered by any appropriate power source, including but not limited to human power, electric power, solar power, internal combustion engines, turbine engines, steam engines, rocket engines, and jet propulsion, as well as any other appropriate power source that may be apparent to those skilled in the relevant art(s) after reading the description herein.

The term “flight zone” and/or the plural form of this term are used throughout herein to refer to any area within the previously defined enclosing apparatus in which the previously defined aerial vehicles may be flown, such as, by way of example and not limitation, a drone flying within a portion of Earth's atmosphere contained within an amount of netting material.

The term “user area” and/or the plural form of this term are used throughout herein to refer to any area wherein one or more users, such as pilots, may control, observe, monitor, rent, purchase, trade, analyze, repair, maintain, learn about, receive training for, engage in consulting for, and/or construct one or more of the previously defined aerial vehicles, as well as engage in similar activities; such as, by way of example and not limitation, a pilot controlling a drone in flight. The “user area” may be configured within the previously defined enclosing apparatus, outside of but attached to the previously defined enclosing apparatus, or outside of and detached from the previously enclosing apparatus. The “user area” may be in an open or at least partially enclosed environment.

The term “user” and/or the plural form of this term are use throughout herein to refer to any individual, business, or other entity that may utilize the previously defined enclosing apparatus and/or any portion thereof, such as aerial vehicle pilots, competition/game observers, instructors, staff members, patrons, and the like.

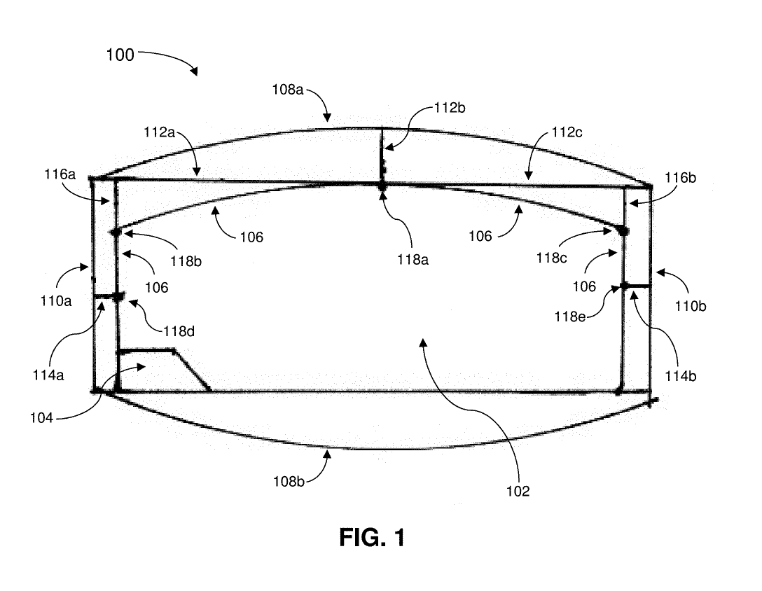

Referring now to FIG. 1, a cutaway side view of an exemplary enclosing apparatus 100 for contained aerial vehicle 728 (not shown in FIG. 1) flight, according to an aspect of the present disclosure, is shown. According to various embodiments, the shape of the apparatus 100 may be a polygon, such as the one depicted in FIG. 1, or it may be other shapes, not shown, such as, a rectangle or multiple rectangles, a polygon or multiple polygons, oblong, circular, or any other shape or shapes as may be designed according to embodiments herein. The shape depicted in FIG. 1 is not intended to be a limitation on the present disclosure.

Enclosing apparatus 100 may comprise at least one flight zone 102 and at least one user area 104. In some aspects, enclosing apparatus 100 may further comprise at least one support structure 300 (not labeled in FIG. 1) and at least one containment boundary 400 (not labeled in FIG. 1). In some additional aspects, enclosing apparatus 100 comprises containment boundary 400 and not support structure 300. In still some additional aspects, enclosing apparatus 100 comprises flight zone 102 and not user area 104.

Flight zone 102 may be an at least partially contained area within containment boundary 400. Containment boundary 400 may be configured to limit the flight of at least one aerial vehicle 728 to a specific area and/or protect aerial vehicles 728 within containment boundary 400 from other aerial vehicles 728, inclement weather conditions, flying debris, animals, various objects, buildings, and similar potential hazards. In some aspects, containment boundary 400 may comprise at least one physical component 106. Physical component 106 may comprise any appropriate material capable of preventing aerial vehicles 728 flown within flight zone 102 from leaving flight zone 102, while being pliable enough to minimize damage to aerial vehicles 728 upon impact with physical component 106, including netting material, canvas, cloth, plastic, rubber, foam, latex, leather, other polymers, and any other appropriate material as may be apparent to those skilled in the relevant art(s) after reading the description herein, as well as any combination thereof.

In some additional aspects, containment boundary 400 may at least partially comprise one or more containment boundary electrical components 730 (not shown in FIG. 1) that generate a type of electrical fence configured to keep aerial vehicles 728 within flight zone 102 by means of sending electrical signals, impulses, and/or other wireless media to at least partially and/or temporarily disable aerial vehicles 728 upon detection that such aerial vehicles 728 have crossed a predetermined point in space and/or force them to land. Such electrical signals, impulses, and/or other wireless media may comprise any type of wireless media, including but not limited to infrared, radio frequency, Bluetooth® (a wireless technology standard standardized as IEEE 802.15.1), acoustic, various types of electromagnetic waves, and any other appropriate signals, impulses, or media that may be apparent to those skilled in the relevant art(s) after reading the description herein, as well as any combination thereof. Various containment boundary electrical components 730 may include, by way of example and not limitation, sensors, lasers, motion detectors, charge-coupled devices (CCDs), near-field communications transceivers, Bluetooth® chips (a wireless technology standard standardized as IEEE 802.15.1), GPS locators, and the like. Containment boundary electrical components 730 may be configured within and/or upon aerial vehicles 728, either temporarily or permanently, flown within flight zone 102 so as to receive any sent disabling signals and cause them to take effect; within and/or upon any of the various components of support structure 300; anywhere within and/or upon user area 104 and/or enclosing apparatus 100, generally, either within and/or upon other objects or as free standing elements; and/or within and/or upon other existing elements, including but not limited to rocks, trees, buildings, lamp posts, and the like. Other appropriate configurations of containment boundary electrical components 730 may be used as may be apparent to those skilled in the relevant art(s) after reading the description herein. Containment boundary electrical components 730 may be secured in place using any appropriate fastening elements, including but not limited to bolts, screws, hooks, welded bonds, clamps, nuts, washers, nails, adhesives, ropes, cables, cable ties, and the like. In yet some further aspects, containment boundary 400 may be entirely comprised of containment boundary electrical components 730, thereby allowing containment boundary 400 to comprise an entirely electronic form.

In some aspects, flight zone 102 may comprise one or more access points, such as doors, windows, hatches, openings, and the like, for one or more users 702 (not shown in FIG. 1) and/or aerial vehicles 728 to enter and/or exit flight zone 102.

Aerial vehicles 728 may be flown within flight zone 102 for any purpose, including for recreation as well as competitive purposes, including races; and commercial purposes, including the paid rental of aerial vehicles 728 and the paid viewing of aerial vehicle 728 competitions or games. In some aspects, flight zone 102 may comprise one or more obstacles which may serve to enhance aerial vehicle 728 flight and/or competition/gameplay by adding a degree of challenge. By way of example and not limitation, obstacles within flight zone 102 may comprise rings or loops that aerial vehicles 728 may be flown through, solid geometric structures that aerial vehicles 728 may be flown around, and any other similar elements as may be apparent to those skilled in the relevant art(s) after reading the description herein. The obstacles may be securely or movably attached to physical component 106 of containment boundary 400 and/or support structure 300, such as with the use of suction cups, adhesives, clips, clamps, clasps, hook-and-loop fasteners, zippers, cable ties, hooks, pins, and/or similar elements. Additionally, in some aspects, the obstacles may be freestanding components within flight zone 102. In yet some additional aspects, some or all of the obstacles may oscillate, rotate, or otherwise move to add additional challenge aspects for users 702. By way of example and not limitation, such movement may be facilitated by one or more electric motors, internal combustion engines, and the like. In still some additional aspects, one or more of the obstacles may at least partially comprise an electronic form by including one or more electronic signals, impulses, and/or other wireless media that function to at least partially and/or temporarily disable aerial vehicles 728 that attempt to fly though certain locations within flight zone 102 and/or force them to land, thereby creating points and/or zones within flight zone 102 that users 702 are challenged with trying to avoid. By way of example and not limitation, obstacles in the electronic form may comprise electrical signals, impulses, and/or other wireless media such as, by way of example and not limitation, infrared, radio frequency, Bluetooth® (a wireless technology standard standardized as IEEE 802.15.1), acoustic, various types of electromagnetic waves, and any other appropriate signals, impulses, and/or other wireless media that may be apparent to those skilled in the relevant art(s) after reading the description herein, as well as any combination thereof.

In some aspects, aerial vehicles 728 flown within flight zone 102 may be fitted with one or more electrical devices to facilitate a variety of competitions or games in which aerial vehicles 728 may be engaged. Such electrical devices may be configured to transmit and/or receive electrical signals, impulses, and/or other wireless media capable of at least partially and/or temporarily disabling any aerial vehicle 728, capable of forcing any aerial vehicle 728 to land, capable of illuminating a light upon and/or soliciting a sound from any aerial vehicle 728, and/or otherwise triggering any type of similar response from any aerial vehicle 728 as may be apparent to those skilled in the relevant art(s) after reading the description herein. The electrical devices may take the form of transmitters and/or receivers. Transmitters may send signals, impulses, and/or other wireless media configured to bring about a response from other aerial vehicles 728, while receivers may be configured to bring about a response from aerial vehicles 728 upon which they are affixed once transmitted signals, impulses, and/or other wireless media are received. Response triggering signals, impulses, and/or other wireless media may be transmitted via user 702 instigation and/or automatically upon the occurrence of variance events. Various types of user instigation 702 may include, by way of example and not limitation, user 702 manipulating a trigger, lever, button, or similar physical mechanism within user area 104; user 702 interacting with user control device 704 (not shown in FIG. 1), either physically (e.g., by manipulating a button or trigger, by stating a verbal command to be received by one or more microphones associated with user control device 704, by gesturing (e.g., by making a motion interpreted by a camera upon user control device 704, by moving user control device 704 a certain way to engage an internal accelerometer, etc.)), or electronically (e.g., via interacting with a graphical user interface, such as, by way of example and not limitation, by using a mouse-click or finger tap to press a virtual button); as well as any other appropriate instigative means as may be apparent to those skilled in the relevant art(s) after reading the description herein. Various types of events that may initiate the automatic sending of response triggering transmissions may include, by way of example and not limitation, an aerial vehicle 728 coming within a certain distance of another aerial vehicle 728, an aerial vehicle 728 being in a certain position relative to another aerial vehicle 728 (such as one aerial vehicle 728 being directly in front of another aerial vehicle 728, or such as multiple aerial vehicles 728 surrounding a single aerial vehicle 728), as well as various other appropriate events that may be apparent to those skilled in the relevant art(s) after reading the description herein. By way of example and not limitation, the response triggering signals, impulses, and/or other wireless media may comprise infrared, radio frequency, Bluetooth® (a wireless technology standard standardized as IEEE 802.15.1), acoustic, various types of electromagnetic waves, and any other appropriate signals, impulses, and/or other wireless media that may be apparent to those skilled in the relevant art(s) after reading the description herein, as well as any combination thereof. Such signals, impulses, and/or other wireless media may be transmitted and/or received from and/or initiated by a variety of different devices, including, by way of example and not limitation, sensors, lasers, motion detectors, charge-coupled devices (CCDs), near-field communications transceivers, Bluetooth® chips (a wireless technology standard standardized as IEEE 802.15.1), GPS locators, and the like. In any case, the response triggering signals, impulses, and/or other wireless media may facilitate engagement in any number of various competitions or games, including but not limited to “capture the flag” (in which aerial vehicles 728 are arranged into at least two teams, and one team attempts to retrieve an opposing team's flag (or similar object) and bring it back to a pre-established base zone), “defend the castle” (in which aerial vehicles 728 are arranged into at least two teams, and each team attempts to keep aerial vehicles 728 from opposing teams from reaching a certain location and/or to keep aerial vehicles 728 from opposing teams from “destroying” an object representing a castle, such as by sending response triggering signals, impulses, and/or other wireless media to be received by the object, whereupon after receiving a certain number of such signals, impulses, and/or other wireless media the “castle” may be deemed destroyed; the “castle” may be protected by sending response triggering signals, impulses, and/or other wireless media to aerial vehicles 728 of the opposing team(s)), as well as any other appropriate competition or game as may be apparent to those skilled in the relevant art(s) after reading the description herein. In aspects where “capture the flag” is the selected competition, the “flag” may comprise an electrical form, wherein upon reaching a certain location within flight zone 102, an aerial vehicle 728 may be detected by one or more sensors, lasers, motion detectors, charge-coupled devices (CCDs), near-field communications transceivers, Bluetooth® chips (a wireless technology standard standardized as IEEE 802.15.1), GPS locators, or similar devices, and the aerial vehicle 728 may receive an electronic signal, impulse, or other wireless media that initiates the indication of possession of a “captured” flag. By way of example and not limitation, initiation of the illumination of a light upon aerial vehicle 728 may indicate possession a captured flag. Such captured flag may be lost if another aerial vehicle 728 transmitter successfully transmits a response triggering signal, impulse, and/or other wireless media that is received by receiver of the aerial vehicle 728 with the captured flag, thereby causing the light to be turned off.

In some aspects, some or all of the obstacles, various components of support structure 300, and/or any other portion of enclosing apparatus 100 may comprise one or more lighting elements, including incandescent light bulbs, fluorescent lamps or tubes, light-emitting diodes, luminescent elements, and the like, to enhance user 702 enjoyment of flight zone 102 and enclosing apparatus 100, generally. In instances when flight zone 102 may be generally dark, illuminating only select obstacles, components of support structure 300, and/or other portions of enclosing apparatus 100 may add a degree of challenge for users 702 flying aerial vehicles 728 within flight zone 102. Such illumination may be constant or sporadic. Optionally, various lighting elements may also be temporarily or permanently affixed to one or more aerial vehicles 728 flown within flight zone 102. Such lighting elements may be programmed to automatically operate a certain way, such as to continuously turn off and on in an intermittent fashion, or they may be manually controlled by user 702 via user control device 704.

In some aspects, support structure 300 is used to at least partially provide physical support for physical component 106 of containment boundary 400. By way of example and not limitation, support structure 300 may comprise a generally cylindrical shape; however, any appropriate shape and/or configuration may be used for support structure 300 as will be appreciated by those skilled in the relevant art(s) after reading the description herein. Support structure 300 may comprise circular portions 108 (labeled as circular portions 108a-b in FIG. 1) at the top and bottom sections thereof. Additionally, support structure 300 may comprise one or more sidewalls 110 (shown as sidewalls 110a-b in FIG. 1). A single sidewall 110 may comprise a solid piece of material that follows the curve of circular portions 108, or sidewalls 110 may comprise any number of pillars, posts, or similar components that are placed at desired intervals capable of providing the required amount of support for top circular portion 108 as well as containment boundary 400, generally. In some additional aspects, support structure 300 comprises four sidewalls 110 configured as pillars/posts, each positioned equidistantly about the circumference of circular portions 108.

The top circular portion 108 of support structure 300 may comprise at least one support segment 112 (shown as support segments 112a-c in FIG. 1) configured to securely receive an upper portion of physical component 106 of containment boundary 400. The top circular portion 108 of support structure 300 may further comprise at least one support pole 116 (shown as support poles 116a-b in FIG. 1) projecting downwardly so as to securely retain an upper portion of physical component 106 of containment boundary 400 at points lower than top circular portion 108 itself, particularly at points towards the outer edge of circular portions 108 so as to facilitate the suspension of physical component 106 of containment boundary 400 in a dome-like or parabolic fashion with a generally circular body and base. In some aspects, support structure 300 may comprise four support poles 116 spaced equidistantly about the circumference of top circular portion 108.

Similar to support poles 116, each of sidewalls 110 may comprise at least one support rod 114 (shown as support rods 114a-b in FIG. 1) projecting inwardly therefrom towards the inner portion of support structure 300. Support rods 114 may securely retain side portions of physical component 106 of containment boundary 400.

Each of support segments 112, support rods 114, and/or support poles 116 may comprise at least one connection mechanism 118 (shown as connection mechanisms 118a-e in FIG. 1) capable of securely retaining at least a portion of physical component 106 of containment boundary 400. By way of example and not limitation, connection mechanisms 118 may comprise one or more hooks, pins, clips, suction cups, rope knots, clamps, clasps, hook-and-loop fasteners, zippers, cable ties, and adhesives, as well as any other similar element(s) as may be apparent to those skilled in the relevant art(s) after reading the description herein, as well as any combination thereof. Physical component 106 may comprise a set of its own corresponding connection mechanisms 118 and/or holes or other elements capable of receiving connection mechanisms 118 associated with the various components of support structure 300.

Each component of support structure 300 may be formed from any appropriately rigid and/or durable material, including, by way of example and not limitation, metals, ropes, cables, cords, concrete, wood, plastics, other polymers, and the like, as well as any combination of such materials. As necessary, various portions of support structure 300 may be welded together or otherwise adjoined so as to establish secure connections, such as with adhesives, physical bonding elements, and the like. Additionally, in some aspects, the various components of support structure 300 may be incorporated with one or more aerial vehicle monitoring components 734 (not shown in FIG. 1), including, by way of example and not limitation, cameras (including night vision cameras), sensors, motion detectors, lasers, charge-coupled devices (CCDs), near-field communications transceivers, Bluetooth® chips (a wireless technology standard standardized as IEEE 802.15.1), GPS locators, and the like, as well as one or more computing devices such as smartphones, tablet computers, gaming consoles, laptop computers, desktop computers, notebook computers, and the like, any of which may be used with one or more software applications. Aerial vehicle monitoring components 734 may be configured to capture various performance aspects of aerial vehicles 728 flown within flight zone 102, such as their location, speed, agility ratings, proximity measurements to obstacles and/or other aerial vehicles 728, as well as any other performance information that may be apparent to those skilled in the relevant art(s) after reading the description herein. In some additional aspects, various aerial vehicle monitoring components 734 may be integrated with one or more aerial vehicles 728 themselves, or may be configured elsewhere within flight zone 102 and/or enclosing apparatus 100, such as, by way of example and not limitation, as freestanding elements or being integrated with other objects. Performance information captured by aerial vehicle monitoring components 734 may be retained, analyzed, and/or offered for display for users 702 of enclosing apparatus 100. By way of example and not limitation, performance information may be displayed upon display screens or scoreboards within user area 104 and/or flight zone 102 that may be communicatively coupled to aerial vehicle monitoring components 734, and/or upon display screens associated with one or more user control devices 704 that may be communicatively coupled to aerial vehicle monitoring components 734 via any appropriate means, such as via a network 706 (not shown in FIG. 1) such as, by way of example and not limitation, the global, public Internet. User control devices 704 may function via one or more software applications. User control devices 704 may include, without limitation, smartphones, tablet computers, gaming consoles, laptop computers, desktop computers, notebook computers, personal digital assistants, and the like, as well as various types of remote control radio wave transmitting and receiving devices, and the like. In some aspects, one or more software applications associated with user control devices 704 may be configured to provide various types of analysis regarding captured performance information, including the ability to rank and/or score aerial vehicles 728 against each other in various categories including speed, agility, and the like.

In some aspects, various components of support structure 300 may at least partially comprise one or more containment boundary electrical components 730 used to form an electronic version of containment boundary 400 that is configured to keep aerial vehicles 728 within flight zone 102 by means of sending electrical signals, impulses, and/or other wireless media to at least partially and/or temporarily disable aerial vehicles 728 that cross a predetermined point in space and/or force them to land. Such electrical signals, impulses, and/or other wireless media may comprise infrared, radio frequency, Bluetooth® (a wireless technology standard standardized as IEEE 802.15.1), acoustic, various types of electromagnetic waves, and any other appropriate signals, impulses, and/or other wireless media that may be apparent to those skilled in the relevant art(s) after reading the description herein, as well as any combination thereof. In yet some additional aspects, such as when support structure 300 is not used with enclosing apparatus 100, containment boundary electrical components 730 may comprise freestanding elements and/or containment boundary electrical components 730 may be integrated within and/or upon other objects, such as rocks, trees, buildings, lamp posts, and the like. By way of example and not limitation, containment boundary electrical components 730 may comprise sensors, lasers, motion detectors, charge-coupled devices (CCDs), near-field communications transceivers, Bluetooth® chips (a wireless technology standard standardized as IEEE 802.15.1), and/or GPS locators, as well as any other similar components that may be apparent to those skilled in the relevant art(s) after reading the description herein, and any combination thereof. Corresponding electrical components 730 may be integrated, either temporarily or permanently, within and/or upon aerial vehicles 728 flown within flight zone 102 so as to receive any sent disabling signals and cause them to take effect. Containment boundary electrical components 730 may be secured in place using any appropriate fastening elements, including but not limited to bolts, screws, hooks, welded bonds, clamps, nuts, washers, nails, adhesives, ropes, cables, cable ties, and the like.

In still some additional aspects, support structure 300 may be integrated with existing structures and/or objects, including but not limited to buildings, trees, lamp posts, and the like. Additionally, support structure 300 may include one or more base components configured to securely attach support structure 300 to the ground or other substantially solid generally flat surface.

User area 104 may comprise an open or an at least partially enclosed area. As shown in FIG. 1, in some aspects, user area 104 may be configured within flight zone 102. In some additional aspects, user area 104 may be configured outside of but connected to flight zone 102 or outside of and detached from flight zone 102. In aspects wherein user area 104 is outside of and detached from flight zone 102, user area 104 may be proximal to flight zone 102 or located completely remotely therefrom. By way of example and not limitation, a user area 104 outside of and detached from flight zone 102 may comprise a residential or commercial building interior, an outdoor location, a building rooftop, or any other appropriate location from which users 702 may control, observe, and/or analyze aerial vehicles 728 within flight zone 102 as may be apparent to those skilled in the relevant art(s) after reading the description herein. In some additional aspects, having user area 104 outside of and detached from flight zone 102 may be desirable for users 702 engaging in aerial vehicle 728 competitions/games, such as races.

User area 104 may comprise a structure composed of any appropriate materials, including metals, concrete, canvas, netting material, ropes, cloth, wood, plastics, glass, other polymers, and the like, as well as any combination thereof. In some aspects, when user area 104 is configured within the range of human visibility of flight zone 102, it may be beneficial to construct user area 104 of materials that allow users 702 within user area 104 to see aerial vehicles 728 within flight zone 102 that they may be controlling and/or otherwise observing or analyzing. In such aspects, such desired visibility may be achieved by using appropriately transparent materials such as glass, netting material, clear plastics, and other similar materials as may be apparent to those skilled in the relevant art(s) after reading the description herein. In aspects wherein user area 104 is configured beyond the range of human visibility of flight zone 102, various electronically assisted viewing components 732 (not shown in FIG. 1) may be integrated with other objects and/or as freestanding elements within flight zone 102 and/or user area 104, and/or may be integrated within and/or upon any of the various components of support structure 300 and/or within and/or upon one or more aerial vehicles 728 flown within flight zone 102, secured either permanently or temporarily, to allow users 702 to control, observe, and/or analyze aerial vehicles 728 within flight zone 102 that cannot be seen directly by utilizing various techniques, such as, by way of example and not limitation, live video streaming. Such electronically assisted viewing components 732 may include, by way of example and not limitation, one or more cameras (including night vision cameras), display screens, motion detectors, and the like, as well as one or more computing devices such as smartphones, tablet computers, gaming consoles, laptop computers, desktop computers, notebook computers, and the like, any of which may be used with one or more software applications. Electronically assisted viewing components 732 may be secured in place using any appropriate fastening elements, including but not limited to bolts, screws, hooks, welded bonds, clamps, nuts, washers, nails, adhesives, ropes, cables, cable ties, and the like.

In some aspects, user area 104 may be at least partially protected from aerial vehicles 728 flying within flight zone 102 by one or more of containment boundary electrical components 730 configured to keep aerial vehicles 728 away from user area 104 and any users 702 within it by means of sending electrical signals, impulses, and/or other wireless media to at least partially and/or temporarily disable aerial vehicles 728 upon detection that such aerial vehicles 728 have crossed a predetermined point in space and/or force them to land. Such electrical signals, impulses, and/or other wireless media may comprise infrared, radio frequency, Bluetooth® (a wireless technology standard standardized as IEEE 802.15.1), acoustic, various types of electromagnetic waves, and any other appropriate signals, impulses, and/or other wireless media that may be apparent to those skilled in the relevant art(s) after reading the description herein, as well as any combination thereof. Containment boundary electrical components 730 may include, by way of example and not limitation, sensors, lasers, motion detectors, charge-coupled devices (CCDs), near-field communications transceivers, Bluetooth® chips (a wireless technology standard standardized as IEEE 802.15.1), GPS locators, and the like. Containment boundary electrical components 730 may be integrated within and/or upon any portion of enclosing apparatus 100, including any physical structure that may at least partially comprise user area 104. Corresponding electrical components 730 may be integrated, either temporarily or permanently, within and/or upon aerial vehicles 728 flown within flight zone 102 so as to receive any sent disabling signals and cause them to take effect. Containment boundary electrical components 730 may be secured in place using any appropriate fastening elements, including but not limited to bolts, screws, hooks, welded bonds, clamps, nuts, washers, nails, adhesives, ropes, cables, cable ties, and the like.

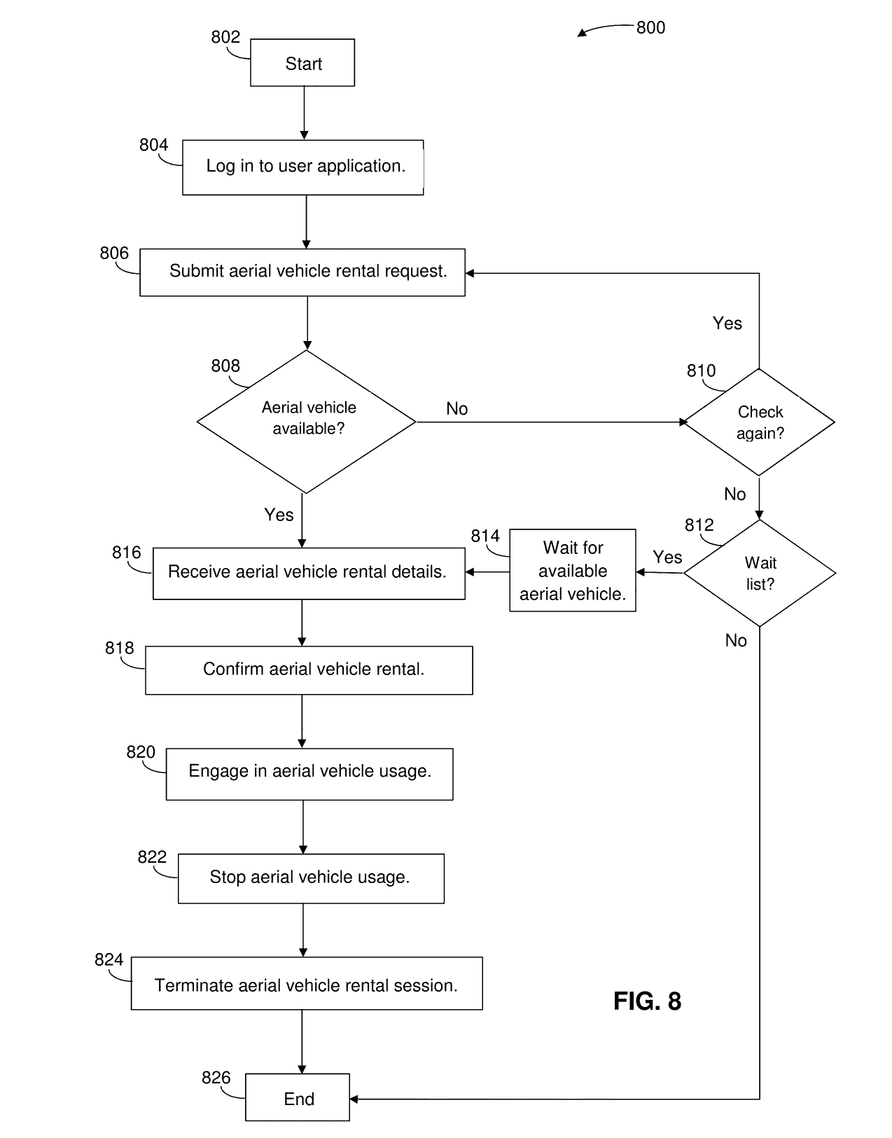

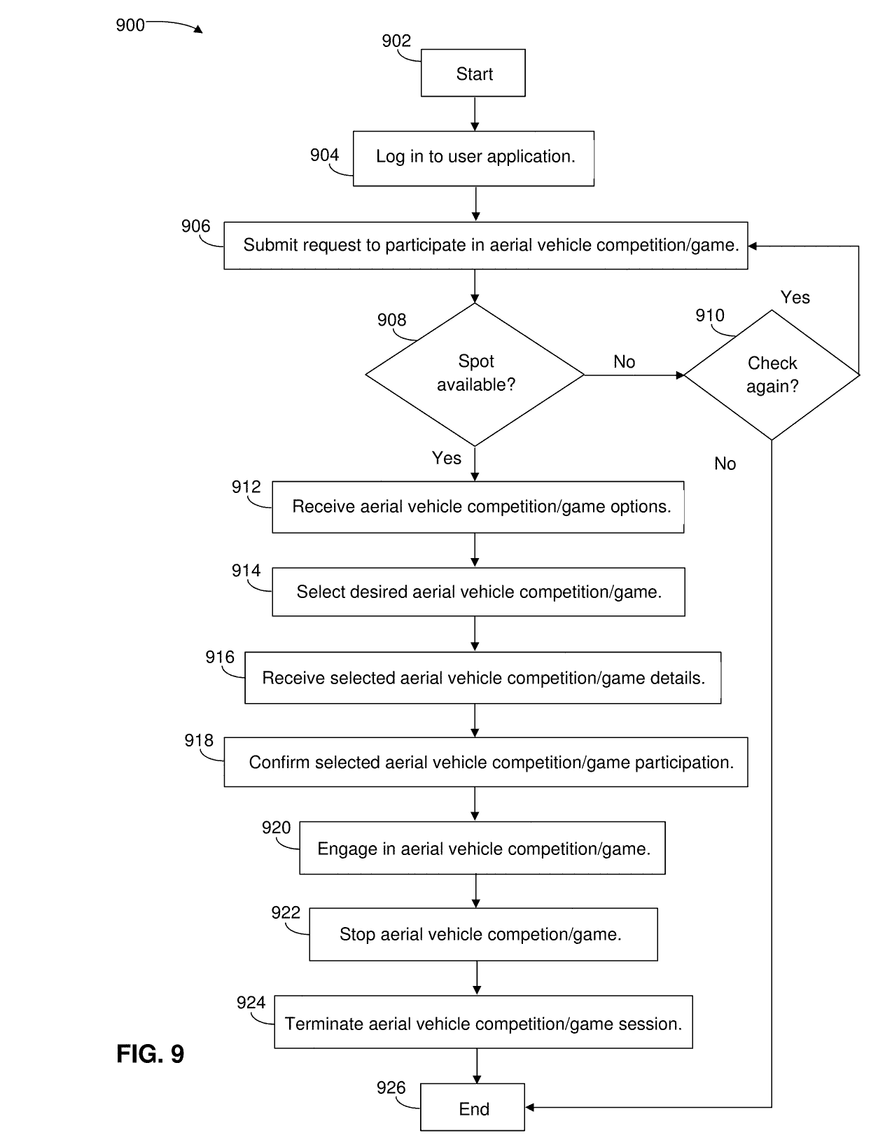

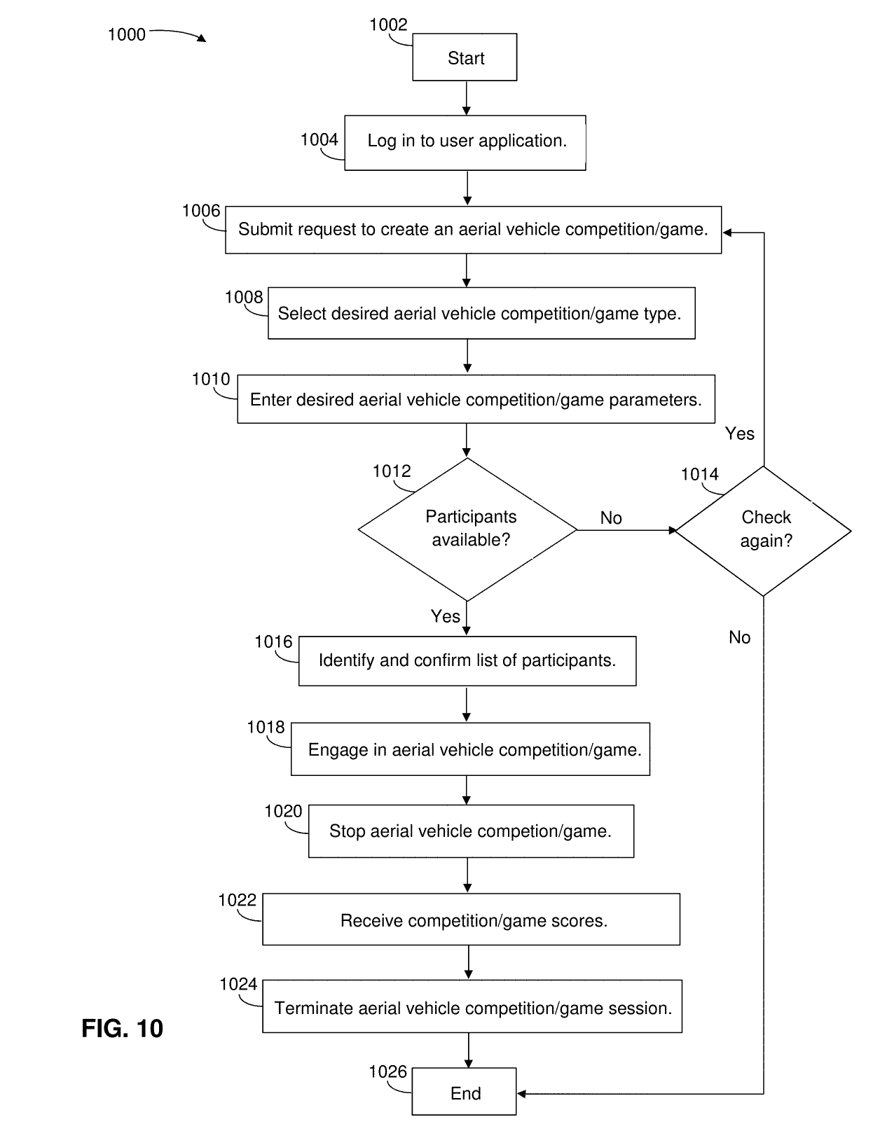

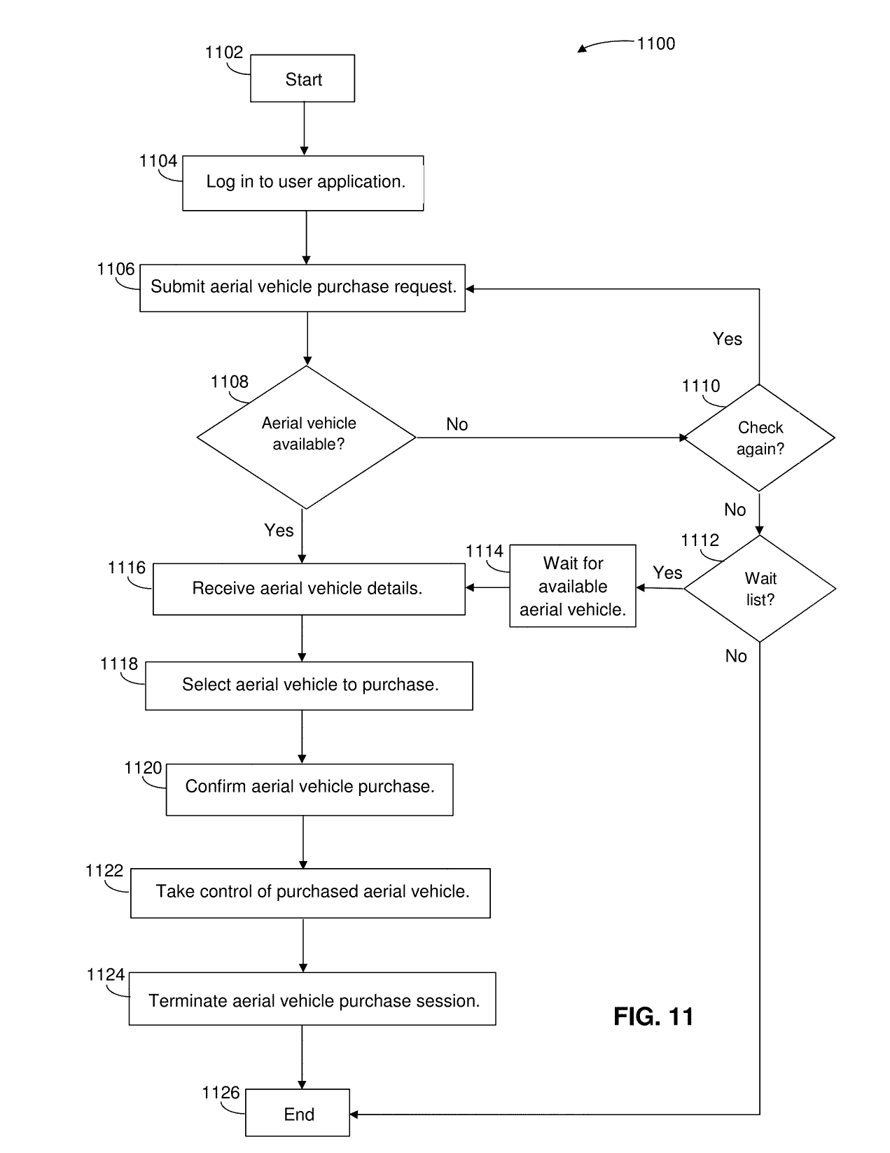

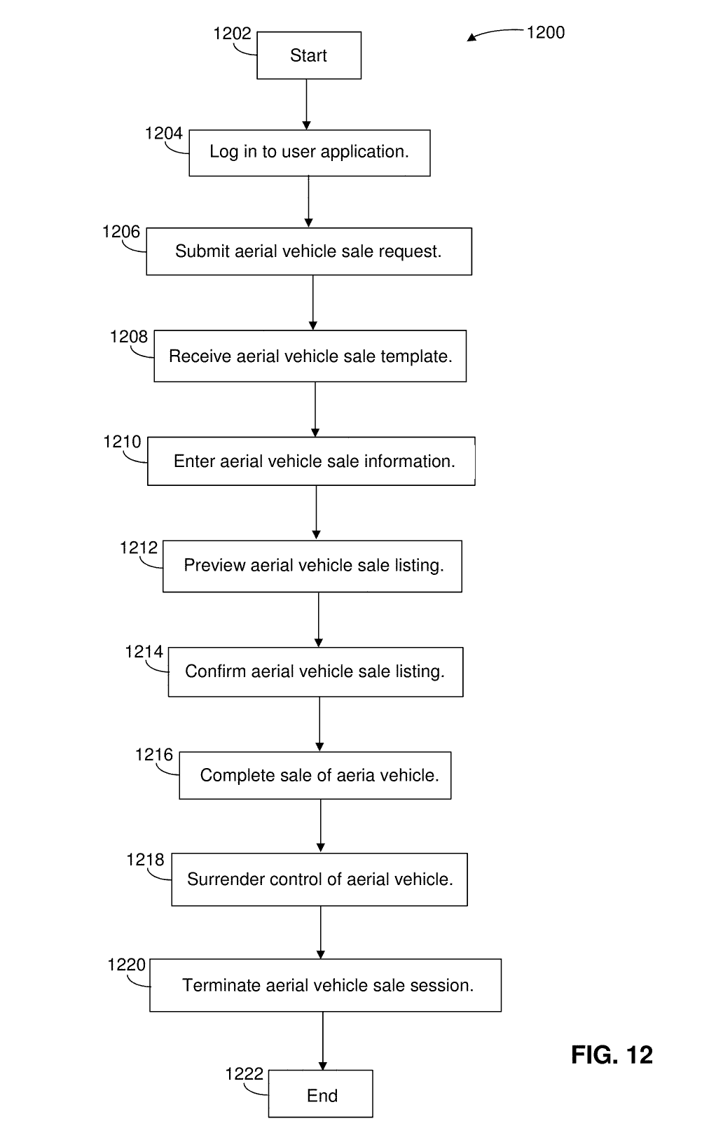

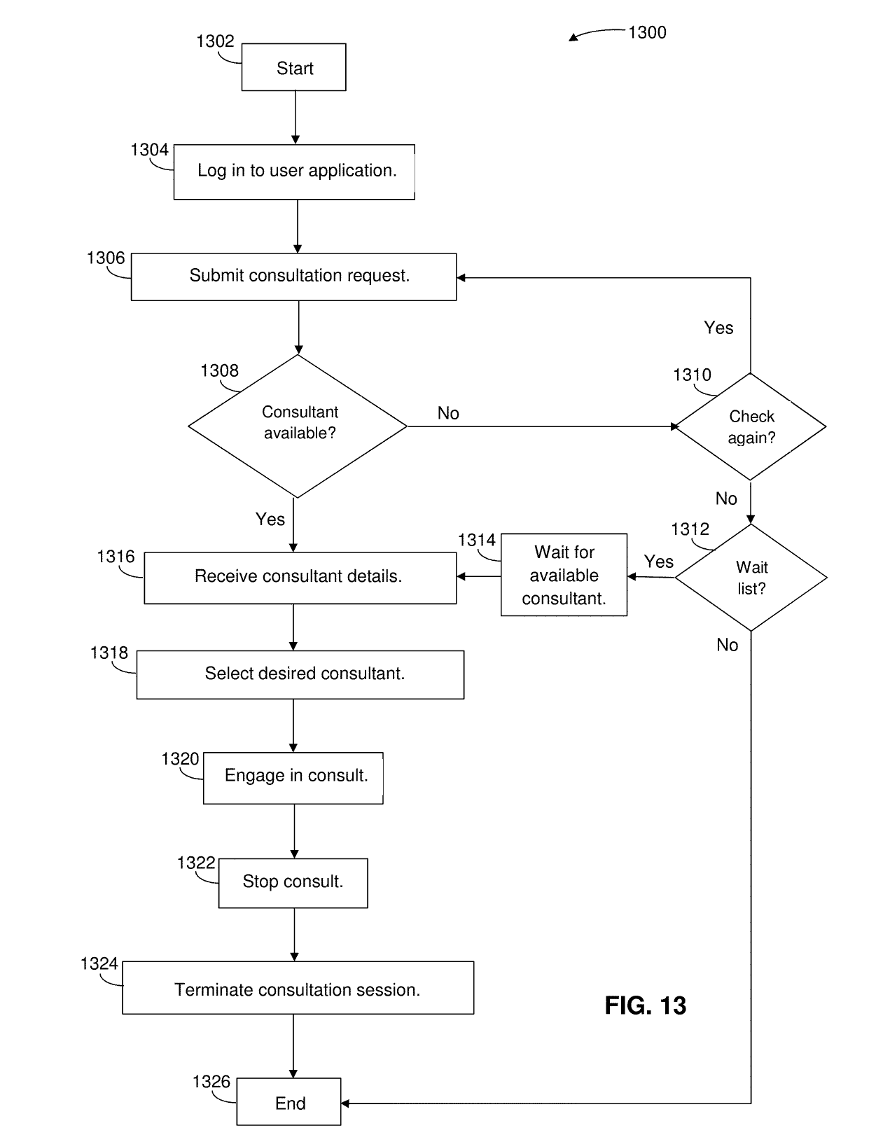

Within user area 104, users 702 may control, observe, and/or analyze aerial vehicles 728 flown within flight zone 102 without being physically exposed to aerial vehicles 728 in flight. Users 702 may control aerial vehicles 728 within flight zone 102 via one or more user control devices 704. User control devices 704 may comprise any appropriate devices as will be appreciated by those skilled in the relevant art(s) after reading the description herein, including but not limited to the previously listed computing devices, such as smartphones, tablet computers, gaming consoles, laptop computers, desktop computers, notebook computers, and the like, any of which may be used with one or more software applications, as well as various types of remote control radio wave transmitting and receiving devices, and the like. Additionally, users 702 within user area 104 may receive training and/or instructions regarding various techniques and/or procedures for flying aerial vehicles 728; may learn about aerial vehicles 728; may monitor, review, and/or analyze the performance of aerial vehicles 728 flown within flight zone 102; may perform repair and/or maintenance tasks upon aerial vehicles 728; may construct whole aerial vehicles 728 or portions thereof; may observe and/or engage in aerial vehicle 728 competitions/games; and may engage in aerial vehicle 728 rentals, purchases, and/or trades; as well as any other appropriate purposes as may be apparent to those skilled in the relevant art(s) after reading the description herein. In some aspects, any of these activities may be performed at least partially via electronic communication over one or more networks 706. By way of example and not limitation, users 702 may use one or more networks 706 to rent aerial vehicles 728 (as shown in FIG. 8), engage in aerial vehicle 728 competitions or games, including custom competitions or games (as shown in FIGS. 9 and 10) purchase aerial vehicles 728 (as shown in FIG. 11), sell aerial vehicles 728 (as shown in FIG. 12), and/or engage in consulting regarding for aerial vehicles 728 (as shown in FIG. 13), and the like.

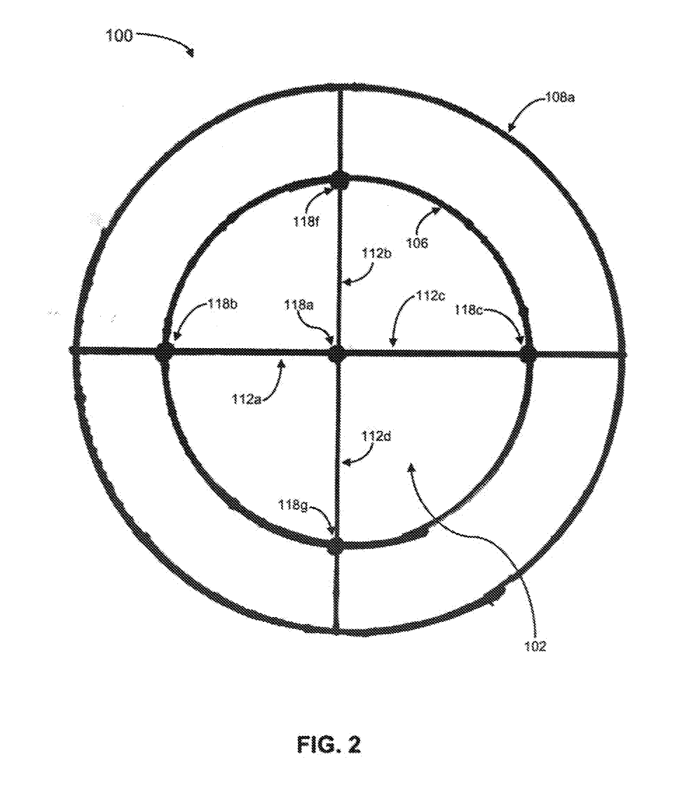

Referring now to FIG. 2, a top view of exemplary enclosing apparatus 100 for contained aerial vehicle 728 (not shown in FIG. 2) flight, according to an aspect of the present disclosure, is shown.

Although a circular design is shown for enclosing apparatus 100, it is noted that any appropriate design may be used as may be apparent to those skilled in the relevant art(s) after reading the description herein.

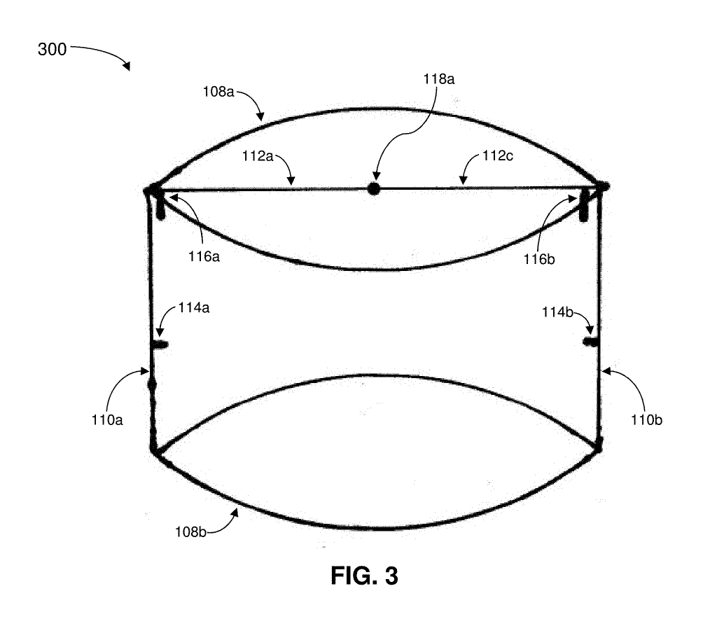

Referring now to FIG. 3, a perspective view of an exemplary support structure 300 for enclosing apparatus 100 for contained aerial vehicle 728 (not shown in FIG. 3) flight, according to an aspect of the present disclosure, is shown.

Enclosing apparatus 100 may be used with or without support structure 300. Among other things, support structure 300 may be useful for providing support and structural shaping to physical component 106 (not shown in FIG. 3) of containment boundary 400 (not shown in FIG. 3), as well as providing added protection for flight zone 102 (not labeled in FIG. 3) and/or user area 104 (not labeled in FIG. 3), generally.

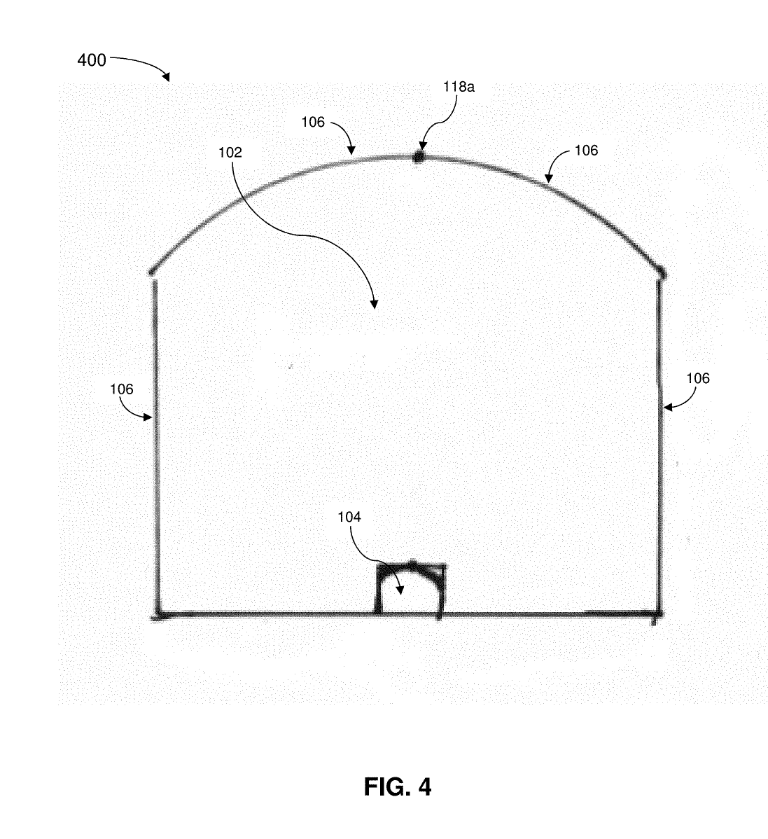

Referring now to FIG. 4, a cutaway side view of an exemplary containment boundary 400 for enclosing apparatus 100 for contained aerial vehicle 728 (not shown in FIG. 4) flight, according to an aspect of the present disclosure, is shown.

As previously described, physical component 106 of containment boundary 400 may comprise a dome-like or parabolic shape, or any other appropriate shape as may be apparent to those skilled in the relevant art(s) after reading the description herein. In some aspects, physical component 106 of containment boundary 400 may comprise a shape and/or configuration that substantially or entirely lacks rigid corners, shapes, edges, and/or other surfaces that may damage aerial vehicles 728 upon impact.

By way of example and not limitation, in addition to the materials listed previously, physical component 106 of containment boundary 400 may comprise a netting material, such as that used in the construction of paintball fields. Containment boundary 400 may comprise a radius of 15 feet and a height of 20 feet; however, as will be appreciated by those skilled in the relevant art(s) after reading the description herein, a plethora of size options and material selections are available for physical component 106 of containment boundary 400 and in no way should the present disclosure be limited to any specific size, material, or other specific configuration.

Although user area 104 is positioned in a central location at the bottom of flight zone 102 within containment boundary 400 in FIG. 4, it is noted that, as described previously, user area 104 may be configured in a variety of locations, as will be appreciated by those skilled in the relevant art(s) after reading the description herein.

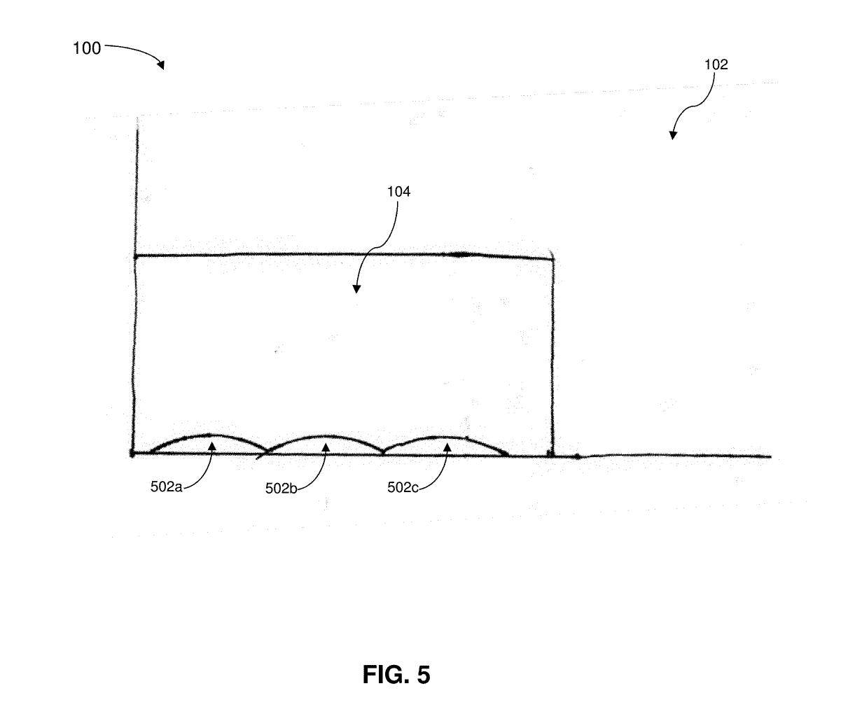

Referring now to FIG. 5, a cutaway side view of an exemplary user area 104 for enclosing apparatus 100 for contained aerial vehicle 728 (not shown in FIG. 5) flight, according to an aspect of the present disclosure, is shown. According to various embodiments, the shape of the apparatus 100 may be a rectangular, such as is depicted in FIG. 5, or it may be other shapes, not shown, such as, a polygon or multiple polygons, oblong, circular, or any other shape or shapes as may be designed according to embodiments herein. The shape depicted in FIG. 5 is not intended to be a limitation on the present disclosure.

User area 104 may be configured so as to offer a comfortable environment for users 702 (not shown in FIG. 5) of enclosing apparatus 100. In some aspects, user area 104 may be configured within flight zone 102, or any other appropriate location as previously discussed. In some additional aspects, user area 104 may comprise a generally rectangular structure with a skeletal support system comprising metallic components. By way of example and not limitation, such rectangular structure may be nine feet long, seven feet tall, and five feet wide, with the skeletal support system comprising four nine feet long metal pipes, four seven feet long metal pipes, and four five feet long metal pipes all welded or otherwise secured together to form a rectangular parallelepiped. Such rectangular parallelepiped may be encased by a sufficiently transparent material, such as netting, that allows users 702 within user area 104 to see aerial vehicles 728 within flight zone 102 when user area 104 is configured within the range of human eyesight of flight zone 102. In some additional aspects, the top and/or bottom portion of user area 104 may be angled so as to provide users 702 better comfort and/or better views of flight zone 102.

At least one door may be included with user area 104 that allows users 702 to enter and/or exit user area 104 from flight zone 102 and/or any other area outside of user area 104 and/or enclosing apparatus 100, generally. In some aspects, such door may comprise a generally parabolic shape and be approximately seven feet tall and four feet wide. The door may be an open space created by rolling a portion of the netting or other material encasing user area 104 up onto itself and securing it in place with one or more fasteners, such as hooks, cable ties, clips, suction cups, clamps, clasps, adhesives, hook-and-loop fasteners, zippers, rope knots, snaps, pins, and the like. Additionally, user area 104 may comprise at least one aerial vehicle 728 entryway 502 (shown as entryways 502a-c in FIG. 5) that allows aerial vehicles 728 to enter and exit user area 104 from flight zone 102 and/or any other area outside of user area 104 and/or enclosing apparatus 100, generally, for the purposes of aerial vehicle 728 retrieval from flight zone 102 and deployment to flight zone 102. In some additional aspects, entryways 502 may comprise a generally parabolic shape that is three feet in diameter. Entryways 502 may be constructed in a similar fashion as the user area 104 door(s). In still some additional aspects, entryways 502 may be placed very close to one another so as to minimize the amount the amount of netting or other material between adjacent entryways 502. Multiple adjacent entryways 502 may be placed side-by-side, may be stacked, or may be arranged in any appropriate fashion as may be apparent to those skilled in the relevant art(s) after reading the description herein. The user area 104 door(s) and/or entryway(s) 502 may be adjustable in size.

As will be appreciated by those skilled in the relevant art(s) after reading the description herein, user area 104 and the doors and entryways 502 associated therewith may comprise any appropriate material(s), shape(s), configuration(s), and size(s) and should in no way be limited to any examples given in the present disclosure.

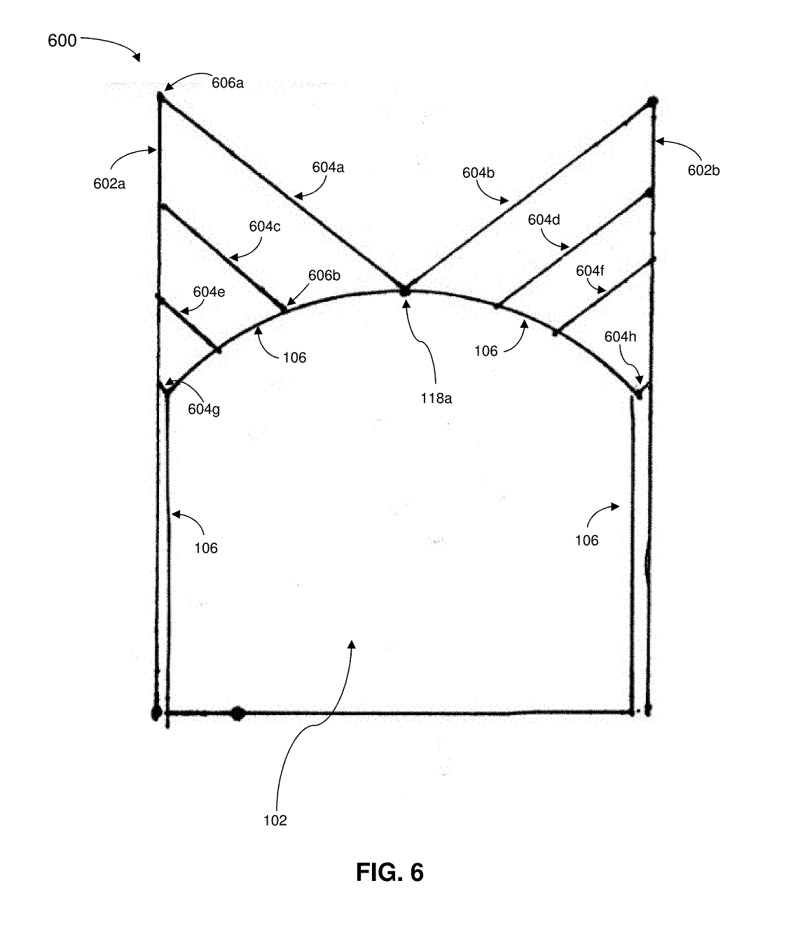

Referring now to FIG. 6, a cutaway side view of a second exemplary enclosing apparatus 600 for contained aerial vehicle 728 (not shown in FIG. 6) flight, according to an aspect of the present disclosure, is shown.

Enclosing apparatus 600 may be substantially similar to enclosing apparatus 100, with a notable difference including the utilization of a different configuration of support structure 300 (not labeled in FIG. 6). In some aspects, enclosing apparatus 600 may be well suited for outdoor environments.

Support structure 300 for enclosing apparatus 600 may comprise at least one freestanding support post 602 (shown as support posts 602a-b in FIG. 6). In some aspects, four support posts 602 are used in a square or rectangular array. Support posts 602 may comprise any sufficiently rigid and durable material, including concrete, wood, metals, plastics, other polymers, and the like.

Support posts 602 may be used in conjunction with at least one support connector 604 (shown as support connectors 604a-h in FIG. 6). Support connectors 604 may comprise at least partially flexible members such as ropes, cables, cords, or similar sufficiently load bearing elements, and/or rigid elements such as rods, arms, hooks, and the like. Rigid elements used as support connectors 604 may comprise any appropriately durable material of reasonable strength as will be appreciated by those skilled in the relevant art(s) after reading the description herein, including, but not limited to, metals, plastics, wood, concrete, other polymers, and the like, as well as any combination thereof. In some aspects, support posts 602 may comprise existing elements, including but not limited to trees, buildings, fences, bridges, lamp posts, and highway overpasses, as well as any number of similarly supportive elements.

Support connectors 604 may attach to a top portion of physical component 106 of containment boundary 400 at various distances from the central point thereof. By way of example and not limitation, support connectors 604 may attach to the top portion of physical component 106 at points that are three, seven, eleven, and/or fifteen linear feet away from the center point of the top portion physical component 106. In some aspects, physical component 106 of containment boundary 400 may be suspended from support connectors 604 in a dome-like or parabolic fashion. However, as will be appreciated by those skilled in the relevant art(s) after reading the description herein, any appropriate attachment point locations for support connectors 604 as well as various physical component 106 configurations may be used.

Distal ends of each support connector 604 may securely or movably attach to an upper portion of a support post 602 and/or a top portion of physical component 106 via at least one connecting element 606 (labeled only as connecting elements 606a-b in FIG. 6, for clarity). Connecting elements 606 may comprise hooks, clamps, clasps, welded bonds, clips, rope knots, suction cups, cable ties, adhesives, zippers, hook-and-loop fasteners, or any other similar component as may be apparent to those skilled in the relevant art(s) after reading the description herein. Physical component 106 and/or support posts 602 may each comprise their own set of corresponding connecting elements 606 and/or holes and/or other elements capable of receiving connecting elements 606 associated with support connectors 604.

Although the present disclosure has generally referred to the containment of aerial vehicles 728, it will be apparent to those skilled in the relevant art(s) after reading the description herein that enclosing apparatus 100 may be adapted for use for the containment of watercraft and submersible vehicles traveling in any liquid medium, including boats and submarines, as well as land vehicles, including cars, trucks, bicycles, construction vehicles, and the like, any of which may be powered by any appropriate means, including but not limited to human power, electric power, solar power, internal combustion engines, turbine engines, steam engines, rocket engines, and jet propulsion, as well as any other appropriate power source that may be apparent to those skilled in the relevant art(s) after reading the description herein.

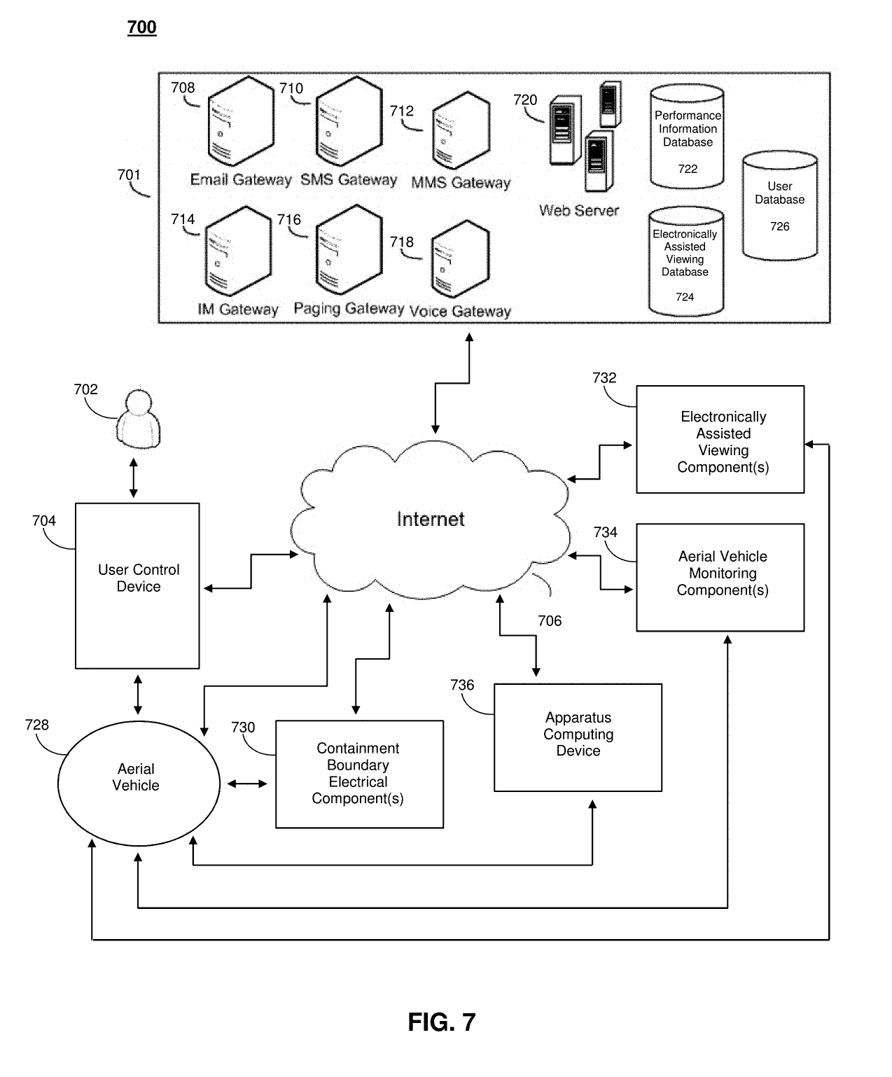

Referring now to FIG. 7, a block diagram of an exemplary system 700 for facilitating electronic communication of information between different components associated with exemplary enclosing apparatus 100, according to an aspect of the present disclosure, is shown.

Although system 700 is described herein as being associated with enclosing apparatus 100, as will be appreciated by those skilled in the relevant art(s) after reading the description herein, some or all of the elements of system 700 may be used independently from enclosing apparatus 100, such as in various embodiments associated with processes 800-1300.

Cloud-based, Internet-enabled device communication system 700 includes a plurality of users 702 accessing—via user control device 704 and a network 706, such as the global, public Internet—an application service provider's cloud-based, Internet-enabled infrastructure 701. Users 702 may access infrastructure 701 in order to facilitate their ability to control at least one aerial vehicle 728 flown within flight zone 102 via user control device 704. Users 702 may also access infrastructure 701 in order to, among other things: observe one or more aerial vehicles 728 within flight zone 102, analyze the performance of one or more aerial vehicles 728 within flight zone 102, view current or past performance information regarding aerial vehicles 728 and/or previously recorded aerial vehicle 728 flights within flight zone 102, share various types of content and/or communicate with other users 702, rent, purchase, and/or sell aerial vehicles 728, participate in and/or create custom aerial vehicle 728 competitions/games, engage in aerial vehicle 728 consulting, and the like. User control device 704 may comprise one or more software applications installed on one or more computing devices, one or more remote control radio wave transmitters and/or receivers, or any similar devices as may be apparent to those skilled in the relevant art(s) after reading the description herein. User control device 704 may be a mobile device or a generally stationary device and/or system, such as, by way of example and not limitation, a fixed computer station within user area 104.

In various aspects, user control device 704 may be configured as: a tablet computing device or mobile computer; a mobile device; a laptop computer; a mobile or cellular telephone; a smartphone; a personal digital assistant (PDA); a desktop computer; a gaming console; any commercially-available intelligent communications device; any remote control radio wave transmitting and/or receiving device; or the like. Such user control devices 704 may comprise one or more sensors such as a camera, a charge-coupled device (CCD), a near-field communications transceiver, a Bluetooth® chip (a wireless technology standard standardized as IEEE 802.15.1), a GPS sensor, and the like. Such sensors may be configured to detect the environmental elements, physical objects, and the like. System 700 may further comprise one or more display screens and/or scoreboards (not shown in FIG. 7) for presenting various types of information and/or content to users 702.

Additionally, system 700 may comprise one or more apparatus computing devices 736. Apparatus computing device 736 may be configured as: a tablet computing device or mobile computer; a mobile device; a laptop computer; a mobile or cellular telephone; a smartphone; a personal digital assistant (PDA); a desktop computer; a gaming console; a standalone computing station or kiosk; any commercially-available intelligent communications device; or the like. Apparatus computing device 736 may facilitate electronic communication between user control device 704 and one or more aerial vehicles 728 flown within flight zone 102. Apparatus computing device may further be configured to engage in electronic communication with user control device 704 and/or one or more aerial vehicles 728 in order to facilitate various tasks, including but not limited to renting, purchasing, and/or selling aerial vehicles 728, engaging aerial vehicle 728 consultations, and setting up and/or regulating participation in aerial vehicle 728 competitions or games.

As shown in FIG. 7, in an aspect of the present disclosure, an application service provider's cloud-based, communications infrastructure 701 may include an email gateway 708, an SMS gateway 710, an MMS gateway 712, an Instant Message (IM) gateway 714, a paging gateway 716, a voice gateway 718, one or more web servers 720, a performance information database 722, an electronically assisted viewing database 724, and a user database 726. As will be apparent to those skilled in the relevant art(s) after reading the description herein, communications infrastructure 701 may include one or more additional storage, communications, and/or processing components to facilitate communication within system 700, process data, store content, and the like.

Performance information database 722 may be configured to store information regarding any performance aspects pertaining to one or more aerial vehicles 728 flown within flight zone 102, either currently or previously. Such performance information may include, by way of example and not limitation, aerial vehicle 728 location, aerial vehicle 728 speed, aerial vehicle 728 agility ratings, previous aerial vehicle 728 competition/gameplay information, aerial vehicle 728 proximity measurements to obstacles and/or other aerial vehicles 728, as well as other types of performance information as may be apparent to those skilled in the relevant art(s) after reading the description herein. The performance information may be offered for display to one or more users 702 via user control device 704 and/or other display screens and/or scoreboards, as well as similar devices, such display taking the form of numbers, charts, graphs, other images, as well as any other appropriate form as may be apparent to those skilled in the relevant art(s) after reading the description herein. Performance information may be captured by one or more aerial vehicle monitoring components 734, including, by way of example and not limitation, cameras (including night vision cameras), sensors, motion detectors, lasers, charge-coupled devices (CCDs), near-field communications transceivers, Bluetooth® chips (a wireless technology standard standardized as IEEE 802.15.1), GPS locators, and the like, as well as one or more computing devices such as smartphones, tablet computers, gaming consoles, laptop computers, desktop computers, notebook computers, and the like, any of which may be used with one or more software applications. Additionally, one or more software applications integrated with any particular user control device 704, may, amongst other things, be configured to perform various types of analysis upon captured performance information and/or compare such analysis with that of other vehicles 728 flown within flight zone 102. Aerial vehicle monitoring components 734 may be configured within and/or upon aerial vehicles 728, either temporarily or permanently, flown within flight zone 102; within and/or upon any of the various components of support structure 300; or anywhere within flight zone 102, user area 104, and/or enclosing apparatus 100, generally, either within and/or upon other objects/components or as free standing elements. Other appropriate configurations of aerial vehicle monitoring components 734 may be used as may be apparent to those skilled in the relevant art(s) after reading the description herein.

Electronically assisted viewing database 724 may be configured to store recorded video and/or images of one or more aerial vehicles 728 flown within flight zone 102, either currently or previously. Such video/images may be captured by one or more electronically assisted viewing components 732, including, by way of example and not limitation, one or more cameras (including night vision cameras), display screens, motion detectors, and the like, as well as one or more computing devices such as smartphones, tablet computers, gaming consoles, laptop computers, desktop computers, notebook computers, and the like, any of which may be used with one or more software applications. Electronically assisted viewing components 732 may be configured within and/or upon aerial vehicles 728, either temporarily or permanently, flown within flight zone 102; within and/or upon any of the various components of support structure 300; or anywhere within flight zone 102, user area 104, and/or enclosing apparatus 100, generally, either within and/or upon other objects or as free standing elements. Other appropriate configurations of electronically assisted viewing components 732 may be used as may be apparent to those skilled in the relevant art(s) after reading the description herein.

User database 726 may be configured to store information about users 702 including, but not limited to: account information; content uploaded; content accessed; infrastructure 701 usage; type of aerial vehicle 728 used; purchase, sale, rental and/or consultation history; statistical and/or performance rankings against other users 702; competition/game scores and/or rankings; and the like. Each user 702 account may be associated with user 702 content uploaded to and/or downloaded from performance information database 722 and/or electronically assisted viewing database 724.

In alternate aspects, user database 726, electronically assisted viewing database 724, or performance information database 722 may comprise one or more data stores within (or remotely located from) infrastructure 701 or be a memory included in (or coupled to) web server 720.

Performance information database 722, electronically assisted viewing database 724, and user database 726 may each be physically separate from one another, logically separate, or physically or logically indistinguishable from some or all other databases.

In some aspects, containment boundary 400 may at least partially comprise an electrical nature, such as a form of electric fencing or similar configuration, that keeps aerial vehicles 728 within flight zone 102 via one or more electrical signals, impulses, or other wireless media designed to at least partially and/or temporarily disable aerial vehicles 728 upon detection that such aerial vehicles 728 have crossed a predetermined point in space and/or force them to land. Such electrical signals, impulses, or other wireless media may comprise any type of wireless media, including but not limited to infrared, radio frequency, Bluetooth® (a wireless technology standard standardized as IEEE 802.15.1), acoustic, various types of electromagnetic waves, and any other appropriate signals, impulses, or wireless media that may be apparent to those skilled in the relevant art(s) after reading the description herein, as well as any combination thereof. Such signals, impulses, and/or other wireless media may be sent/transmitted/established by one or more containment boundary electrical components 730 including, by way of example and not limitation, sensors, lasers, motion detectors, charge-coupled devices (CCDs), near-field communications transceivers, Bluetooth® chips (a wireless technology standard standardized as IEEE 802.15.1), GPS locators, and the like. Containment boundary electrical components 730 may be configured within and/or upon aerial vehicles 728, either temporarily or permanently, flown within flight zone 102; within and/or upon any of the various components of support structure 300; or anywhere within and/or upon user area 104 and/or enclosing apparatus 100, generally, either within and/or upon other objects or as free standing elements. Other appropriate configurations of containment boundary electrical components 730 may be used as may be apparent to those skilled in the relevant art(s) after reading the description herein. In some aspects, containment boundary electrical components 730 may be configured to form at least part of a barrier between user area 104 and aerial vehicles 128 flown within flight zone 102. In some additional aspects, containment boundary electrical components 730 may form an entirely electronic form of containment boundary 400 and/or an entirely electronic barrier between user area 104 and aerial vehicles 728 flown within flight zone 102.

As will be appreciated by those skilled in the relevant art(s) after reading the description herein, in such an aspect, an application service provider—an individual person, business, or other entity—may allow access, on a free registration, paid subscriber, and/or pay-per-use basis, to infrastructure 701 via one or more World-Wide Web (WWW) sites on the Internet 706. Thus, system 700 is scalable.

As will also be appreciated by those skilled in the relevant art(s), in an aspect, various screens would be generated by server 720 in response to input from users 702 over Internet 706. That is, in such an aspect, server 720 is a typical web server running a server application at a website which sends out webpages in response to Hypertext Transfer Protocol (HTTP) or Hypertext Transfer Protocol Secured (HTTPS) requests from remote browsers on various user control devices 704 being used by various users 702. Thus, server 720 is able to provide a graphical user interface (GUI) to users 702 of system 700 in the form of webpages. These webpages are sent to the user's PC, laptop, mobile device, PDA, or like device 704, and would result in the GUI being displayed.

As will be appreciated by those skilled in the relevant art(s) after reading the description herein, alternate aspects of the present disclosure may include providing a tool for facilitating the control, observation, and/or analysis of one or more aerial vehicles 728 via user control devices 704 as a stand-alone system (e.g., installed on one server PC) or as an enterprise system wherein all the components of system 700 are connected and communicate via an inter-corporate Wide Area Network (WAN) or Local Area Network (LAN). For example, in an aspect where users 702 are all personnel/employees of the same company or are all members of the same group, the present disclosure may be implemented as a stand-alone system, rather than as a web service (i.e., Application Service Provider (ASP) model utilized by various unassociated/unaffiliated users) as shown in FIG. 7.

As will also be appreciated by those skilled in the relevant art(s) after reading the description herein, alternate aspects of the present disclosure may include providing the tools for facilitating the control, observation, and/or analysis of aerial vehicles 728 via infrastructure 701 and user control devices 704 via a browser or operating system pre-installed with an application or a browser or operating system with a separately downloaded application on such user control devices 704. That is, as will also be apparent to one skilled in the relevant art(s) after reading the description herein, the application that facilitates the aerial vehicle controlling, observing, and analyzing platform disclosed herein may be part of the “standard” browser or operating system that ships with user control device 704 or may be later added to an existing browser or operating system as part of an “add-on,” “plug-in,” or “app store download.”

Referring now to FIG. 8, a flowchart illustrating an exemplary process 800 for electronically obtaining at least temporary control of an aerial vehicle 728 via one or more networks 706, according to an aspect of the present disclosure, is shown.

Process 800 may be used in conjunction with enclosing apparatus 100 or as an independent process in a variety of environments suitable for aerial vehicle 728 flight, such as large rooms, open fields, and the like. In an aspect, process 800 allows one or more users 702 to rent at least temporary access to at least one aerial vehicle 728 via one or more networks 706. Such rental may occur with users 702 being physically present at the site at which aerial vehicles 728 will be flown, or with users 702 being remotely located from the flight location.

Process 800, which may at least partially execute within system 700, begins at step 802 with control passing immediately to step 804.

At step 804, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 800 proceeds to step 806.

At step 806, infrastructure 701 receives a rental request from a particular user 702 to obtain at least temporary control of an aerial vehicle 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 800 proceeds to step 808.

At step 808, infrastructure 701 determines whether any aerial vehicles 728 are currently available to rent. In some aspects, infrastructure 701 may be associated with at least one aerial vehicle 728 which can be detected and at least partially controlled by infrastructure 701. Control may be passed to various users 702 upon completing a successful rental request. In some additional aspects, users 702 must meet certain criteria before being allowed to gain control of any aerial vehicle 728 associated with infrastructure 701. By way of example and not limitation, such criteria may include users 702 having to obtain a certain license(s), having to complete various forms of registration, having to make certain payment(s), as well as meet any similar requirements as may be apparent to those skilled in the relevant art(s) after reading the description herein.

If infrastructure 701 determines that an aerial vehicle 728 is available, process 800 proceeds to step 816. If infrastructure 701 determines that no aerial vehicles 728 are currently available, process 800 proceeds to step 810.

At step 810, infrastructure 701 queries user 702 to determine whether user 702 desires another check to be performed to find an available aerial vehicle 728 to rent. If user 702 responds in the affirmative, process 800 proceeds back to step 806. In some aspects, the repeated request may be sent automatically without further action by user 702. If user 702 responds in the negative, process 800 proceeds to step 812.

At step 812, infrastructure 701 queries user 702 to determine whether user 702 would like to be placed on a wait list until an aerial vehicle 728 is available for rent. In order to make this decision, user 702 may view the current wait list to see how many, if any, other users 702 are currently waiting and/or get an approximate wait time. In some aspects, rental sessions for aerial vehicles 728 may be time limited so that as many users 702 get a turn to use aerial vehicles 728 as possible. Taking into account the remaining time limits on currently rented aerial vehicles 728 may help determine approximate wait times.

If user 702 responds to the query in the affirmative, process 800 proceeds to step 814. If user 702 responds in the negative, process 800 proceeds to step 826.

At step 814, infrastructure 701 reserves a spot on the wait list for user 702. User 702 thus waits for an aerial vehicle 728 to become available. In some aspects, user 702 may arrange for infrastructure 701 to notify user 702 when an aerial vehicle 728 is available so that user 702 may engage in other activities while waiting. By way of example and not limitation, a notification may comprise a sound, such as a beep or ring; a visual cue, such as an illuminated light or a text message; a physical sensation, such as a vibration; or any other indication that may be apparent to those skilled in the relevant art(s) after reading the description herein. Such notification may be delivered via user control device 704. Once an aerial vehicle 728 becomes available, process 800 proceeds to step 816.

At step 816, infrastructure 701 presents user 702 with rental details for one or more available aerial vehicles 728. The details may be presented to user 702 via a display screen associated with user control device 704, or via any other appropriate means. Rental details may include, by way of example and not limitation, aerial vehicle 728 type (e.g., tricopter, quadcopter, etc.), aerial vehicle 728 model information (e.g., manufacturer, serial number, etc.), aerial vehicle 728 use history (e.g., total flight time, rental frequency, etc.), rental duration time, rental cost details, rules associated with aerial vehicle 728 usage, as well as any similarly appropriate information as may be apparent to those skilled in the relevant art(s) after reading the description herein. In some aspects, user 702 may be presented with rental details for one aerial vehicle 728 at a time, and may either accept that aerial vehicle 728 or decline it and be presented with rental details for a different rental vehicle 728. Such process may be repeated indefinitely until all available aerial vehicles 728 for rent have been declined or until an available aerial vehicle 728 has been selected, whichever occurs first. In some additional aspects, user 702 may be presented with rental details for several available aerial vehicles 728 from which to choose. In still some additional aspects, user 702 may be presented with rental details for every available aerial vehicle 728 from which to choose. Rental details for rental vehicles 728 that are not currently available may also be presented in case use 702 decides to wait for a preferred aerial vehicle 728. In any case, when more than one aerial vehicle 728 is available for rent, rental details for aerial vehicles 728 may be presented in order of user 702 preference settings within a user 702 account or profile, in order of user 702 use history based on aerial vehicles 728 most often selected by user 702, in order of aerial vehicle 728 popularity, in order of how soon aerial vehicles 728 will become available, or in any other appropriate order as may be apparent to those skilled in the relevant art(s) after reading the description herein. Process 800 then proceeds step 818.

At step 818, infrastructure 701 receives confirmation of the rental of a particular aerial vehicle 728 from user 702. If more than one aerial vehicle 728 was available at step 816, user 702 selects which aerial vehicle 728 to use. Additionally, in some aspects, payment may be established at this step. The cost for renting aerial vehicle 728 may be determined on a per use basis or with regard to various time parameters. By way of example and not limitation, time parameters may comprise a cost per minute, per hour, per day, or any other appropriate block of time as may be apparent to those skilled in the relevant art(s) after reading the description herein. In some additional aspects, cost may take the form of a subscription. By way of example and not limitation, user 702 may pay a certain amount per month or per year in order to have limited or unlimited access to aerial vehicle 728 rentals during that time. Other subscription times may be used as well as will be appreciated by those skilled in the relevant art(s) after reading the description herein.

User 702 may pay for a rental at the time of confirmation, any time after a rental session has been completed, at any time prior to rental, or as part of a subscription. When payment is made before a rental occurs, user 702 may have the option to reserve the availability of an aerial vehicle 728 for a particular day and/or time. Such a reservation may be made for any available aerial vehicle 728, for any aerial vehicle 728 that meets certain criteria (such as, by way of example and not limitation, being a certain model and/or being made by a certain manufacturer), or for a particular aerial vehicle 728. Payment may be made by any appropriate means as will be recognized by those skilled in the relevant art(s), including by using credit cards, debit cards, PayPal® (available from PayPal Holdings, Inc. of San Jose, Calif.), and the like.

Additionally, rental confirmation may include a time limit on the rental session. Such a time limit may serve to help regulate payments as well as provide greater accessibility to aerial vehicle 728 rentals to more users 702. Time limits may comprise any appropriate length as may be deemed appropriate by those skilled in the relevant art(s) after reading the description herein, including but not limited to half an hour, an hour, three hours, and the like.

Confirmation of the rental of aerial vehicle 728 may be achieved by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once confirmation has been completed, process 800 proceeds to step 820.

At step 820, user 702 engages in the use of aerial vehicle 728. Infrastructure 701 establishes an electronic communication link between the aerial vehicle 728 to be rented and user control device 704 that allows user 702 to control aerial vehicle 728 via user control device 704. In some aspects, various devices, such as, by way of example and not limitation, containment boundary electrical components 730, may function to keep rented aerial vehicle 728 within a defined rental environment, such as, by way of example and not limitation, flight zone 102 of enclosing apparatus 100. If infrastructure 701 determines that a rented aerial vehicle 728 is leaving the defined rental environment, infrastructure 701 may take control of that aerial vehicle 728 and either bring it back or keep it within the defined rental environment, with or without assistance from a human administrator. Control may or may not be returned to the user 702 guilty of taking/attempting to take the aerial vehicle 728 out of the defined rental environment.

Process 800 then proceeds to step 822.

At step 822, infrastructure 701 determines that user 702 has stopped using aerial vehicle 728. This may be the result of user 702 choice or upon the expiration of time for the rental session. If it is the result of user 702 choice, user 702 may fly aerial vehicle 728 to a predetermined location at which it will be effectively returned to control of infrastructure 701, or user 702 may use user control device 704 to indicate to infrastructure 701 that user 702 is done with aerial vehicle 728 and infrastructure 701 will thereby take control of aerial vehicle 728 regardless of its location. Such an indication may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. If the rental session time expires before user 702 returns aerial vehicle 728, then infrastructure 701 may intervene by cutting off control of aerial vehicle 728 from user control device 704 and restoring such control of aerial vehicle 728 to infrastructure 701 itself. Infrastructure 701 then may fly aerial vehicle 728 to an appropriate storage and/or maintenance location automatically, or a human administrator of infrastructure 701 may fly aerial vehicle to a desired location for storage and/or maintenance. Process 800 then proceeds to step 824.

At step 824, the rental session is terminated. All communication links between user control device 704 and aerial vehicle 728 are closed. Additionally, in some aspects, user 702 may log out of the user application associated with infrastructure 701.

Process 800 then terminates at step 826.

Referring now to FIG. 9, a flowchart illustrating an exemplary process 900 for participating in an aerial vehicle 728 competition or game via one or more networks 706, according to an aspect of the present disclosure, is shown.

Process 900 may be used in conjunction with enclosing apparatus 100 or function completely independently therefrom. In an aspect, process 900 allows one or more users 702 to utilize one or more networks 706 to engage in a variety of competitions or games involving aerial vehicles 728. Competitions/games may be configured for two or more users 702 to compete against and/or play with each other, or competitions/games may be configured for single users 702 to try to achieve high scores, practice competition/game performance techniques, as well as for any other similar purpose as may be apparent to those skilled in the relevant art(s) after reading the description herein.

Process 900, which may at least partially execute within system 700, begins at step 902 with control passing immediately to step 904.

At step 904, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 900 proceeds to step 906.

At step 906, infrastructure 701 receives a request from user 702 to participate in a competition or game for aerial vehicles 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 900 proceeds to step 908.

At step 908, infrastructure 701 determines whether there are any spots in existing competitions or games that have available room for more participants. Such competitions/games may be currently active and be configured such that participating and/or new users 702 can join and/or leave at any time, while other competitions/games may be in a preparation phase and are waiting to have a full participating user 702 list before starting. Start times for such competitions/games may be moments away from participating user 702 joinder or may be hours, days, or even years away. In some aspects, users 702 may be required to meet certain criteria before being allowed to participate in an aerial vehicle 728 competition or game. By way of example and not limitation, such criteria may include users 702 having to obtain a certain license(s) to fly aerial vehicles 728, having to complete various forms of registration, having to make certain payment(s), as well as meet any similar requirements as may be apparent to those skilled in the relevant art(s) after reading the description herein.

If infrastructure 701 determines that an aerial vehicle 728 competition or game is available to join, process 900 proceeds to step 912. If infrastructure 701 determines that no aerial vehicle 728 competitions/games are currently available to join, process 900 proceeds to step 910. It is noted that if no competitions or games are currently available, user 702 may opt to create a competition or game as depicted in FIG. 10.

At step 910, infrastructure 701 queries user 702 to determine whether another check should be performed to find an available aerial vehicle 728 competition or game to join. If user 702 responds in the affirmative, process 900 proceeds back to step 906. In some aspects, the repeated request may be sent automatically without further action by user 702. In some additional aspects, user 702 may choose to have infrastructure 701 continuously check for available competitions/games for an indefinite or defined period of time and, once a competition or game is available, infrastructure 701 may be directed to send a notification to user 702 regarding such availability. By way of example and not limitation, a notification may comprise a sound, such as a beep or ring; a visual cue, such as an illuminated light or a text message; a physical sensation, such as a vibration; or any other indication that may be apparent to those skilled in the relevant art(s) after reading the description herein. Such notification may be delivered via user control device 704. If user 702 responds in the negative, process 900 proceeds to step 926.

At step 912, infrastructure 701 presents user 702 with a list comprising at least one option for an available aerial vehicle 728 competition or game to join. By way of example and not limitation, the list may be presented upon a display screen associated with user control device 704. Various types of competitions/games that may be available to join may include, without limitation, “capture the flag,” “defend the castle,” any type of race, performance matching exercises, maneuver copying, as well as any other type of competition or game as may be apparent to those skilled in the relevant art(s) after reading the description herein. Each available competition/game may be presented with information to help user 702 decide which competition/game is more desirable. Such information may include, by way of example and not limitation, how many other participating users 702 may engage in the competition/game, identities (e.g., screennames and the like) of current participants, competition/game duration, competition/game rules, competition/game cost(s) (if applicable), competition/game start time, prize(s) available for winner(s), previous winners and/or high scores, and the like.

In some aspects, user 702 may be presented with information for a single aerial vehicle 728 competition or game, and may either accept that competition/game or decline it and be presented with information for a different competition/game, which may be accepted or declined. Such process may be repeated indefinitely until all competitions/games have been declined or until a competition/game has been accepted, whichever occurs first. In some additional aspects, user 702 may presented with information for several available aerial vehicle 728 competitions/games from which to choose. In still some additional aspects, user 702 may be presented with information for every available aerial vehicle 728 competition/game from which to choose. Information for competitions/games that are not currently available may also be presented in case user 702 decides to wait for a preferred competition/game type. In any case, when more than one aerial vehicle 728 competition/game is presented to user 702, information for those competitions/games may be presented in order of user 702 preference settings within a user 702 account or profile, in order of user 702 participation history based on competitions/games most often selected by user 702, in order of competition/game popularity, in order of how soon competitions/games will begin, in order of competition/game duration, or in any other appropriate order as may be apparent to those skilled in the relevant art(s) after reading the description herein. Process 900 then proceeds step 914.

At step 914, infrastructure 701 receives a selection from user 702 regarding which aerial vehicle 728 competition or game user 702 desires to participate in. By way of example and not limitation, such selection may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once a selection has been made, process 900 proceeds to step 916.

At step 916, infrastructure 701 presents details regarding the selected aerial vehicle 728 competition or game to user 702, such as, by way of example and not limitation, via a display screen associated with user control device 704. The presented details may include any information that was previously available at step 912, as well as any information that was not previously presented for the sake of brevity. After such details have been presented, process 900 proceeds to step 918.

At step 918, infrastructure 701 receives confirmation from user 702 regarding the desire to participate in the selected competition or game. Additionally, in some aspects, payment may be established at this step. The cost for participating in an aerial vehicle 728 competition/game may be determined on a per competition/game basis or with regard to various time parameters, depending, in part, on how the particular competition/game is set up. By way of example and not limitation, time parameters may comprise a cost per minute, per hour, per day, or any other appropriate block of time as may be apparent to those skilled in the relevant art(s) after reading the description herein. In some additional aspects, cost may take the form of a subscription. By way of example and not limitation, user 702 may pay a certain amount per month or per year in order to have limited or unlimited access to participate in aerial vehicle 728 competitions/games during that time. Other subscription times may be used as well as will be appreciated by those skilled in the relevant art(s) after reading the description herein.

User 702 may pay for competition or game participation at the time of confirmation, any time after a competition/game has been completed, any time prior to a competition/game, or as part of a subscription. When payment is made before a competition/game takes place, user 702 may have the option to reserve a spot in the competition/game that is known to be occurring at a particular day and/or time. Such a reservation may be made for any available aerial vehicle 728 competition/game, for any aerial vehicle 728 competition/game that meets certain criteria (such as, by way of example and not limitation, being a certain type, starting at a certain time, having a certain duration, etc.), or for a particular aerial vehicle 728 competition/game. Payment may be made by any appropriate means as will be recognized by those skilled in the relevant art(s), including by using credit cards, debit cards, PayPal® (available from PayPal Holdings, Inc. of San Jose, Calif.), and the like.

Confirmation of participation in an aerial vehicle 728 achieved by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once confirmation has been completed, process 900 proceeds to step 920.

At step 920, user 702 engages in the selected aerial vehicle 728 competition or game. Infrastructure 701 establishes a communication link between user control device 704 and the competition/game environment, including, but not limited to, at least one live video stream. Such live video stream may, in some aspects, be provided by electronically assisted viewing components 732. In some further aspects, the competition/game environment may comprise flight zone 102 of enclosing apparatus 100; however, as will be appreciated by those skilled in the relevant art(s) after reading the description herein, any sufficiently large area that allows for aerial vehicle 728 flight may be used as the competition/game environment, including but not limited to open fields and large rooms. In aspects wherein enclosing apparatus 100 is the competition/game environment, apparatus computing device 736 may comprise at least part of the communication link between the competition/game environment and user control device 704. During the competition or game, scores and/or other performance data may be made available to some or all participants, such as, by way of example and not limitation, upon display screens associated with user control devices 704, upon one or more display screens and/or scoreboards associated with the competition/game environment, upon one or more display screens associated with apparatus computing device 736, or any other appropriate location as may be apparent to those skilled in the relevant art(s) after reading the description herein. Process 900 then proceeds to step 922.

At step 922 infrastructure 701 receives an indication that user 702 has stopped participation in the aerial vehicle 728 competition/game. Such an indication may comprise the expiration of a certain period of time, one or more participating users 702 winning by accomplishing an objective, user 702 indicating a decision to stop, one or more certain rules being violated, or upon the occurrence of any other relevant event. If user 702 decides to stop participation in a competition/game, such a decision may be indicated to infrastructure 701 by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Process 900 then proceeds to step 924.

At step 924, the competition or game session is terminated with regard to user 702. All communication links between user control device 704 and the aerial vehicle 728 competition/game environment are closed. Additionally, in some aspects, user 702 may log out of the user application associated with infrastructure 701.

Process 900 terminates at step 926.

Referring now to FIG. 10, a flowchart illustrating an exemplary process 1000 for creating an aerial vehicle 728 competition or game to be engaged in via one or more networks 706, according to an aspect of the present disclosure, is shown.

Process 1000 may be used in conjunction with enclosing apparatus 100 or function completely independently therefrom. In an aspect, process 1000 facilitates the ability of user 702 to create an aerial vehicle 728 competition or game to be engaged in by a group of at least two users 702 competing/playing against/with each other by utilizing one or more networks 706. In some aspects, a custom competition or game may be created for participation by a single user 702 in order to try to achieve a high score, to practice competition/game performance techniques, or for any other purpose. User 702 may decide to create a competition/game, for example, if none are available to join or if user 702 desires to partake in hosting a competition/game with customized rules and/or settings, as well as for any other reason. Competitions/games may be created with the assistance of one or more forms of software either preinstalled on user control device 704 or available to be downloaded and/or installed on user control device 704, or accessed by user control device 704 via network 706 and/or any other appropriate means as may be apparent to those skilled in the relevant art(s) after reading the description herein.

Process 1000, which may at least partially execute within system 700, begins at step 1002 with control passing immediately to step 1004.

At step 1004, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 1000 proceeds to step 1006.

At step 1006, infrastructure 701 receives a request from user 702 to create a custom competition or game for one or more aerial vehicles 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 1000 proceeds to step 1008.

At step 1008, infrastructure 701 receives a selection from user 702 regarding the type of competition or game that is desired to be created. User 702 may select a general template to start from in order to move through the creation process more quickly, or user 702 may design a completely new competition/game from scratch using various tools and resources provided by the one or more forms of software mentioned previously. By way of example and not limitation, available competition/game type templates may include “capture the flag,” “defend the castle,” any type of race, performance matching exercises, maneuver copying, as well as any other type of competition or game that may be apparent to those skilled in the relevant art(s) after reading the description herein. Competition/game type selection may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once a selection has been made, process 1000 proceeds to step 1010.

At step 1010, infrastructure 701 receives the desired parameters for the aerial vehicle 728 competition or game to be created from user 702. By way of example and not limitation, such parameters may include competition/game rules, how many other participating users 702 may engage in the competition/game, competition/game duration, competition/game environment location (such as, without limitation, enclosing apparatus 100), competition/game cost(s) (if applicable), competition/game start time, prize(s) available for winner(s), and the like. The parameters may be entered via any appropriate method, such as, by means of example and not limitation, by utilizing a graphical user interface on a display screen associated with user control device 704 along with one or more input mechanisms including a mouse, keyboard, joystick, finger tap(s), and the like. Process 1000 then proceeds to step 1012.

At step 1012, infrastructure 701 determines whether there are any participating users 702 available to join the created competition or game. Potential participating users 702 may be searching infrastructure 701 for a competition/game to partake in, and such potential participating users 702 may be made aware of the created competition/game's availability via a search results list, a notification (such as a sound, light illumination, vibration, text message, etc.), or via any other appropriate means as may be apparent to those skilled in the relevant art(s) after reading the description herein. In some aspects, potential participating users 702 may be required to meet certain criteria before being allowed to participate in an aerial vehicle 728 competition/game. By way of example and not limitation, such criteria may include potential participating users 702 having to obtain a certain license(s) to fly aerial vehicles 728, having to complete various forms of registration, having to make certain payment(s), as well as meet similar requirements as may be apparent to those skilled in the relevant art(s) after reading the description herein.

For a potential participating user 702 to become an actually available participating user 702, the potential participating user 702 must express interest in participating in the created competition or game. By way of example and not limitation, interest may be expressed by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein.

In some aspects, a created aerial vehicle 728 competition or game may be configured as a solo competition/game, with creating user 702 being the sole participant. This may be so that user 702 can practice various competition/game tasks, try to beat various high scores, or for any other desirable reason. In such aspects, creating user 702 meets the available participating user 702 requirement and no further search is required.

If infrastructure 701 determines that participating users 702 are available to join the created aerial vehicle 728 competition or game, process 1000 proceeds to step 1016. If infrastructure 701 determines that no participating users 702 are currently available to join, process 1000 proceeds to step 1014.

At step 1014, infrastructure 701 queries user 702 to determine whether another check should be performed to find any available participating users 702 to join the created aerial vehicle 728 competition or game. If user 702 responds in the affirmative, process 1000 proceeds back to step 1006. In some aspects, such repeated request may be sent automatically without further action by user 702. In some additional aspects, user 702 may choose to have infrastructure 701 continuously check for available participating users 702 for an indefinite or defined period of time and, once at least one additional participating user 702 is available, infrastructure 701 may be directed to send a notification to user 702 regarding such availability. By way of example and not limitation, a notification may comprise a sound, such as a beep or ring; a visual cue, such as an illuminated light or a text message; a physical sensation, such as a vibration; or any other indication that may be apparent to those skilled in the relevant art(s) after reading the description herein. Such notification may be delivered via user control device 704. If user 702 responds in the negative, process 1000 proceeds to step 1026.

At step 1016, infrastructure 701 receives a confirmed list of identified participating users 702 from user 702. In an aspect, user 702 may decide which (if not all) of the available participating users 702 will be allowed to participate in the created aerial vehicle 728 competition or game. This may be accomplished in any appropriate manner, such as, by way of example and not limitation, by using a graphical user interface upon a display screen associated with user control device 704 in conjunction with one or more input mechanisms such as a mouse, keyboard, joystick, finger tap(s), and the like. In some aspects, the first available participating users 702 to express interest in participating in the competition/game are selected, either automatically or manually, until all available spots are full, on a first-come, first-served basis. If there is no limit as to how many participating users 702 may join, then participating users 702 may be added for a certain time duration or until a minimum desired number of participating users 702 have joined. In some additional aspects, available participating users 702 may be selected, either automatically or manually, based on a variety of factors, including but not limited to skill level, competition/game experience, type of aerial vehicle 728 being used, personal relationship to creating user 702 and/or other participating users 702, and the like.

If the created competition or game requires the formation of teams, creating user 702 may have teams selected manually or automatically based on any number of factors, including the chronological order in which participating users 702 expressed interest, participating user 702 skill level, participating user 702 competition/game experience, type of aerial vehicle 728 being used by participating user 702, personal relationship or participating user 702 to creating user 702 and/or other participating users 702, and the like. In some aspects, team captains may be determined by infrastructure 701 or creating user 702 and the team captains may select team members.

Once the confirmed list of participating users 702 is submitted, process 1000 proceeds to step 1018.

At step 1018, infrastructure 701 grants access to the created aerial vehicle 728 competition or game. Infrastructure 701 establishes a communication link between the user control device 704 for each participating user 702 and the competition/game environment, including, but not limited to, at least one live video stream. Such live video stream may, in some aspects, be provided by electronically assisted viewing components 732. In some further aspects, the competition/game environment may comprise flight zone 102 of enclosing apparatus 100; however, as will be appreciated by those skilled in the relevant art(s) after reading the description herein, any sufficiently large area that allows for aerial vehicle 728 flight may be used as the competition/game environment, including but not limited to open fields and large rooms. In aspects wherein enclosing apparatus 100 is the competition/game environment, apparatus computing device 736 may comprise at least part of the communication link between the competition/game environment and user control device(s) 704. During the competition or game, scores and/or other performance data may be made available to some or all participants, such as, by way of example and not limitation, upon display screen(s) associated with user control device(s) 704, upon one or more display screens and/or scoreboards associated with the competition/game environment, upon one or more display screens associated with apparatus computing device 736, or any other appropriate location as may be apparent to those skilled in the relevant art(s) after reading the description herein. Process 1000 then proceeds to step 1020.

At step 1020, infrastructure 701 receives an indication to stop the created aerial vehicle 728 competition or game. Such an indication may comprise the expiration of a certain period of time, one or more participating users 702 winning by accomplishing an objective, creating user 702 submitting a command to stop the competition/game, one or more certain rules being violated, or upon the occurrence of any other relevant event. If creating user 702 submits a command to stop the competition/game, such a command may be submitted to infrastructure 701 by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. In some aspects, the competition/game is not stopped, but rather any user 702 may decide to stop participation in the competition/game at any time as in step 922 of process 900. Process 1000 then proceeds to step 1022.

At step 1022, final scores and/or other performance metrics for the various aerial vehicle 728 competition/game participating users 702 are determined by infrastructure 701 and may be offered for display via a display screen(s) associated with user control device(s) 704, one or more display screens and/or scoreboards associated with the competition/game environment, one or more display screens associated with apparatus computing device 736, or by any other appropriate means as may be apparent to those skilled in the relevant art(s) after reading the description herein. If teams are utilized in the created competition or game, then team scores and/or statistics may be determined and displayed in addition to individual scores and/or statistics. Process 1000 then proceeds to step 1024.

At step 1024, the created aerial vehicle 728 competition/game session is terminated at least with regard to creating user 702. In some aspects, the competition/game session is terminated for all participating users 702. All communication links between the applicable user control device(s) 704 and the aerial vehicle 728 competition/game environment are closed. Additionally, in some aspects, creating user 702 may log out of the user application associated with infrastructure 701.

Process 1000 is terminated at step 1026.

Referring now to FIG. 11, a flowchart illustrating an exemplary process 1100 for electronically purchasing and taking control of an aerial vehicle 728 via one or more networks 706, according to an aspect of the present disclosure, is shown.

Process 1100 may be used in conjunction with enclosing apparatus 100 or as a completely independent process therefrom. In an aspect, process 1100 allows user 702 to use one or more networks 706 to electronically purchase an aerial vehicle 728 and subsequently take control of that aerial vehicle 728 via user control device 704.

Process 1100, which may at least partially execute within system 700, begins at step 1102 with control passing immediately to step 1104.

At step 1104, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 1100 proceeds to step 1106.

At step 1106, infrastructure 701 receives a purchase request from a particular user 702 to buy at least one aerial vehicle 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 1100 proceeds to step 1108.

At step 1108, infrastructure 701 determines whether any aerial vehicles 728 are currently listed as being available to purchase. In some aspects, infrastructure 701 may be associated with at least one list of aerial vehicle 728 that are for sale. The lists may be generated and maintained by system 700, or the lists may be generated and maintained by third parties. Infrastructure 701 may be configured to search any and/or all lists on demand, or to periodically search the lists in order to keep an accurate inventory of available aerial vehicles 728 for sale for quick presentation to users 702.

If infrastructure 701 determines that at least one aerial vehicle 728 is available for purchase, process 1100 proceeds to step 1116. If infrastructure 701 determines that no aerial vehicles 728 are currently available for purchase, process 1100 proceeds to step 1110.

At step 1110, infrastructure 701 queries user 702 to determine whether user 702 desires another check to be performed to find an available aerial vehicle 728 to purchase. If user 702 responds in the affirmative, process 1100 proceeds back to step 1106. In some aspects, the repeated request may be sent automatically without further action by user 702. If user 702 responds in the negative, process 1100 proceeds to step 1112.

At step 1112, infrastructure 701 queries user 702 to determine whether user 702 would like to be placed on a wait list until an aerial vehicle 728 is available for purchase. In order to make this decision, user 702 may view the current wait list to see how many, if any, other users 702 are currently waiting. In some aspects, being placed on a wait list may give users 702 first notice and selection of any newly listed aerial vehicles 728 for sale, thereby allowing users 702 on the wait list to have a better chance of getting a desired aerial vehicle 728.

If user 702 responds to the query in the affirmative, process 1100 proceeds to step 1114. If user 702 responds in the negative, process 1100 proceeds to step 1126.

At step 1114, infrastructure 701 reserves a spot on the aerial vehicle 728 purchase wait list for user 702. User 702 thus waits for an aerial vehicle 728 to become available to buy. In some aspects, user 702 may arrange for infrastructure 701 to send a notification to user 702 when an aerial vehicle 728 becomes available. By way of example and not limitation, a notification may comprise a sound, such as a beep or ring; a visual cue, such as an illuminated light or a text message; a physical sensation, such as a vibration; or any other indication that may be apparent to those skilled in the relevant art(s) after reading the description herein. Such notification may be delivered via user control device 704. In some aspects, user 702 may direct infrastructure 701 to only send a notification if an available aerial vehicle 728 meets certain criteria, such as, by way of example and not limitation, being a certain model and/or being made by a certain manufacturer. Once an aerial vehicle 728 becomes available, process 1100 proceeds to step 1116.

At step 1116, infrastructure 701 presents user 702 with details for one or more available aerial vehicles 728 to purchase. The details may be presented to user 702 via a display screen associated with user control device 704, or via any other appropriate means. Aerial vehicle 728 details may include, by way of example and not limitation, aerial vehicle 728 type (e.g., tricopter, quadcopter, etc.), aerial vehicle 728 model information (e.g., manufacturer, serial number, etc.), aerial vehicle 728 use history (e.g., total flight time, type of previous uses, etc.), purchase cost details, as well as any similarly appropriate information as may be apparent to those skilled in the relevant art(s) after reading the description herein. In some aspects, user 702 may be presented with details for one aerial vehicle 728 at a time, and may either accept that aerial vehicle 728 to purchase or decline it and be presented with details for a different aerial vehicle 728 to purchase. Such process may be repeated indefinitely until all available aerial vehicles 728 for purchase have been declined or until an available aerial vehicle 728 has been selected to buy, whichever occurs first. In some additional aspects, user 702 may be presented with details for several available aerial vehicles 728 from which to choose. In still some additional aspects, user 702 may be presented with details for every available aerial vehicle 728 from which to choose. Details for aerial vehicles 728 that are not currently available may also be presented in case use 702 decides to wait for a preferred aerial vehicle 728 to buy. In any case, when more than one aerial vehicle 728 is available for purchase, details for aerial vehicles 728 may be presented in order of user 702 preference settings within a user 702 account or profile, in order of user 702 purchase history based on aerial vehicles 728 most often selected by user 702 (if applicable), in order of aerial vehicle 728 popularity, or in any other appropriate order as may be apparent to those skilled in the relevant art(s) after reading the description herein. Process 1100 then proceeds step 1118.

At step 1118, infrastructure 701 receives a selection form user 702 regarding one or more aerial vehicles 728 to purchase. By way of example and not limitation, such selection may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Process 1100 then proceeds to step 1120.

At step 1120, infrastructure 701 receives confirmation from user 702 regarding the purchase of one or more aerial vehicles 728. User 702 may pay for aerial vehicle(s) 728 at the time of confirmation, any time after purchase confirmation has been completed, or at any time prior to purchase confirmation. Payment may be made by any appropriate means as will be recognized by those skilled in the relevant art(s), including by using credit cards, debit cards, PayPal® (available from PayPal Holdings, Inc. of San Jose, Calif.), and the like.

Additionally, purchase confirmation may include a time frame on when aerial vehicle 728 will be made available to purchasing user 702. Such a time frame may be on the order of seconds (or less), days, weeks, months, or even years.

Confirmation of the purchase of aerial vehicle(s) 728 may be achieved by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once confirmation has been completed, process 1100 proceeds to step 1122.

At step 1122, infrastructure 701 gives control of purchased aerial vehicle 728 to purchasing user 702 via, by way of example and not limitation, user control device 704. User 702 may then fly aerial vehicle 728 to any desired location for storage, maintenance, use, or similar activity. Process 1100 then proceeds to step 1124.

At step 1124, the purchase session is terminated. In some aspects, user 702 may log out of the user application associated with infrastructure 701.

Process 1100 then terminates at step 1126.

Referring now to FIG. 12, a flowchart illustrating an exemplary process 1200 for electronically selling and surrendering control of an aerial vehicle 728 via one or more networks 706, according to an aspect of the present disclosure, is shown.

Process 1200 may be used in conjunction with enclosing apparatus 100 or as a completely independent process therefrom. In an aspect, process 1200 allows user 702 to use one or more networks 706 to electronically sell an aerial vehicle 728 and subsequently surrender control of that aerial vehicle 728 via user control device 704.

Process 1200, which may at least partially execute within system 700, begins at step 1202 with control passing immediately to step 1204.

At step 1204, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 1200 proceeds to step 1206.

At step 1206, infrastructure 701 receives a sale request from a particular user 702 to sell at least one aerial vehicle 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 1200 proceeds to step 1208.

At step 1208, infrastructure 701 presents user 702 with a template to create a sale listing for at least one aerial vehicle 728. Such a template may have inputs for basic information regarding the aerial vehicle(s) 728 to be sold. In some aspects, the template may be customizable. Process 1200 then proceeds to step 1210.

At step 1210, infrastructure 701 receives information from user 702 regarding the aerial vehicle(s) 728 for sale into the template. Information may include, by way of example and not limitation, aerial vehicle 728 type (e.g., tricopter, quadcopter, etc.), aerial vehicle 728 model information (e.g., manufacturer, serial number, etc.), aerial vehicle 728 use history (e.g., total flight time, type of previous uses, etc.), cost details, as well as any similarly appropriate information as may be apparent to those skilled in the relevant art(s) after reading the description herein. Such information may be entered via any appropriate means as may be apparent to those skilled in the relevant art(s) after reading the description herein, including, without limitation, via keyboard entry, mouse-clicks, finger taps, and the like. Process 1200 then proceeds to step 1212.

At step 1212, infrastructure 701 presents user 702 with a preview of the generated sale listing. Such a preview may be made available via, by way of example and not limitation, a display screen associated with user control device 704. Process 1200 then proceeds to step 1214.

At step 1214, infrastructure 701 receives confirmation of the sale listing for aerial vehicle 728 from user 702.

User 702 may pay for the sale listing at the time of confirmation, any time after the sale listing has been completed or ended, at any time prior to the sale listing, or as part of a subscription. Payment may be made by any appropriate means as will be recognized by those skilled in the relevant art(s), including by using credit cards, debit cards, PayPal® (available from PayPal Holdings, Inc. of San Jose, Calif.), and the like.

Additionally, the sale listing confirmation may include a time limit on the duration of the sale listing. Such a time limit may serve to help regulate payments as well as help user 702 monitor how long one or more aerial vehicle(s) 728 have been on the market. Time limits may comprise any appropriate length as may be deemed appropriate by those skilled in the relevant art(s) after reading the description herein, including but not limited to a week, a month, a year, and the like.

Confirmation of the sale listing of aerial vehicle 728 may be achieved by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once confirmation has been completed, process 1200 proceeds to step 1216.

At step 1216, a sale of aerial vehicle 728 is completed when a purchasing user 702 buys the listed aerial vehicle 728, such as, by way of example and not limitation, in process 1100 above. Process 1200 then proceeds to step 1218.

At step 1218, infrastructure 701 takes control of sold aerial vehicle 728 away from selling user 728 and transfers it to purchasing user 702 via, by way of example and not limitation, user control device 704. Purchasing user 702 may then fly aerial vehicle 728 to any desired location for storage, maintenance, use, or similar activity. Process 1200 then proceeds to step 1220.

At step 1220, the sale session is terminated. In some aspects, user 702 may log out of the user application associated with infrastructure 701.

Process 1200 then terminates at step 1222.

Referring now to FIG. 13, a flowchart illustrating an exemplary process 1300 for engaging in an electronic consultation regarding at least one aerial vehicle 728 via one or more networks 706, according to an aspect of the present disclosure, is shown.

Process 1300 may be used in conjunction with enclosing apparatus 100 or as a completely independent process therefrom. In an aspect, process 1300 allows user 702 to use one or more networks 706 to electronically engage in a consultation session with one or more consultants regarding one or more aerial vehicles 728 via user control device 704. Consultants may be utilized by users 702 to learn more about aerial vehicle(s) and/or how to fly or otherwise operate them, learn about aerial vehicle 728 flight safety, learn about aerial vehicle 728 flight rules, receive help regarding aerial vehicle 728 maintenance and/or troubleshooting concerns, learn aerial vehicle 728 competition or game rules, as well as for any other similar purpose as may be apparent to those skilled in the relevant art(s) after reading the description herein.

Process 1300, which may at least partially execute within system 700, begins at step 1302 with control passing immediately to step 1304.

At step 1304, user 702 logs into a user application associated with infrastructure 701 via user control device 704. User 702, or user control device 704, may provide log in credentials, thereby accessing a user 702 account or profile for user 702. By way of example and not limitation, log in credentials may comprise a username, password, passcode, fingerprint scan, retinal scan, and/or any similar identifying and/or security elements as may be apparent to those skilled in the relevant art(s) after reading the description herein. In some aspects, user 702 may log in using a login service such as a social media login service, an identity/credential provider service, a single sign on service, and the like. In various aspects, users 702 may create user 702 accounts/profiles via such login services. Such user 702 accounts/profiles may, in some aspects, be stored within user database 726. Once user 702 is successfully logged in, process 1300 proceeds to step 1306.

At step 1306, infrastructure 701 receives a sale request from a particular user 702 to engage in a consultation session with at least one consultant regarding at least one aerial vehicle 728. By way of example and not limitation, such request may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Once the request has been made, process 1300 proceeds to step 1308.

At step 1308, infrastructure 701 determines whether any consultants are currently available to engage in a consultation session. In some aspects, infrastructure 701 may be associated with at least one list of aerial vehicle 728 consultants. Such lists may be generated and maintained by system 700, or the lists may be generated and maintained by third parties. Infrastructure 701 may be configured to search any and/or all lists on demand, or to periodically search the lists in order to keep an accurate inventory of available aerial vehicle 728 consultants for sale for quick presentation to users 702.

If infrastructure 701 determines that at least one aerial vehicle 728 consultant is available, process 1300 proceeds to step 1316. If infrastructure 701 determines that no aerial vehicle 728 consultants are currently available, process 1300 proceeds to step 1310.

At step 1310, infrastructure 701 queries user 702 to determine whether user 702 desires another check to be performed to find an available aerial vehicle 728 consultant. If user 702 responds in the affirmative, process 1300 proceeds back to step 1306. In some aspects, the repeated request may be sent automatically without further action by user 702. If user 702 responds in the negative, process 1300 proceeds to step 1312.

At step 1312, infrastructure 701 queries user 702 to determine whether user 702 would like to be placed on a wait list until an aerial vehicle 728 consultant is available. In order to make this decision, user 702 may view the current wait list to see how many, if any, other users 702 are currently waiting. In some aspects, being placed on a wait list may give users 702 first notice and selection of any newly available aerial vehicles 728 consultant, thereby allowing users 702 on the wait list to have a better chance of getting a desired aerial vehicle 728 consultant and/or a better chance of getting an aerial vehicle 728 consulting session faster.

If user 702 responds to the query in the affirmative, process 1300 proceeds to step 1314. If user 702 responds in the negative, process 1100 proceeds to step 1326.

At step 1314, infrastructure 701 reserves a spot on the aerial vehicle 728 consultant list for user 702. User 702 thus waits for an aerial vehicle 728 consultant to become available. In some aspects, user 702 may arrange for infrastructure 701 to send a notification to user 702 when an aerial vehicle 728 consultant becomes available. By way of example and not limitation, a notification may comprise a sound, such as a beep or ring; a visual cue, such as an illuminated light or a text message; a physical sensation, such as a vibration; or any other indication that may be apparent to those skilled in the relevant art(s) after reading the description herein. Such notification may be delivered via user control device 704. In some aspects, user 702 may direct infrastructure 701 to only send a notification if an available aerial vehicle 728 consultant meets certain criteria, such as, by way of example and not limitation, having a certain type of expertise, having a certain amount of experience, having a certain user rating, and the like. Once an aerial vehicle 728 consultant becomes available, process 1300 proceeds to step 1316.

At step 1316, infrastructure 701 presents user 702 with details for one or more available aerial vehicle 728 consultants. The details may be presented to user 702 via a display screen associated with user control device 704, or via any other appropriate means. Aerial vehicle 728 consultant details may include, by way of example and not limitation, aerial vehicle 728 consultant type (e.g., troubleshooter, flight instructor, technician, etc.), aerial vehicle 728 consultant years of experience, aerial vehicle 728 consultant expertise (e.g., engine repair, electronic issues, etc.), as well as any similarly appropriate information as may be apparent to those skilled in the relevant art(s) after reading the description herein. In some aspects, user 702 may be presented with details for one aerial vehicle 728 consultant at a time, and may either accept that aerial vehicle 728 consultant to engage with or decline it and be presented with details for a different aerial vehicle 728 consultant. Such process may be repeated indefinitely until all available aerial vehicle 728 consultants have been declined or until an available aerial vehicle 728 consultant has been selected, whichever occurs first. In some additional aspects, user 702 may be presented with details for several available aerial vehicle 728 consultants from which to choose. In still some additional aspects, user 702 may be presented with details for every available aerial vehicle 728 consultant from which to choose. Details for aerial vehicle 728 consultants that are not currently available may also be presented in case use 702 decides to wait for a preferred aerial vehicle 728 consultant. In any case, when more than one aerial vehicle 728 consultant is available, details for aerial vehicle 728 consultants may be presented in order of user 702 preference settings within a user 702 account or profile, in order of user 702 history based on aerial vehicle 728 consultants most often selected by user 702 (if applicable), in order of aerial vehicle 728 consultant popularity and/or rating, or in any other appropriate order as may be apparent to those skilled in the relevant art(s) after reading the description herein. Process 1300 then proceeds to step 1318.

At step 1318, infrastructure 701 receives a selection form user 702 regarding one or more aerial vehicle 728 consultants to engage with. By way of example and not limitation, such selection may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. Process 1300 then proceeds to step 1320.

At step 1320, infrastructure 701 facilitates the engagement of user 702 in a consult with the selected consultant. The consult may, by way of example and not limitation, take place via an established connection between user 702's user control device 704 and the consultant's user control device 704 by infrastructure 701. The consult may comprise a video and/or audio chat session utilizing one or more cameras, microphones, and/or speakers associated with user control device(s) 704, a text-based chat session utilizing one or more keyboards or similar input devices associated with user control device(s) 704, and combination thereof, as well as any similar means as may be apparent to those skilled in the relevant art(s) after reading the description herein. User 702 may pay for the aerial vehicle 728 consult at the time of the session, any time after the session has been completed, or at any time prior to the session. Payment may be made by any appropriate means as will be recognized by those skilled in the relevant art(s), including by using credit cards, debit cards, PayPal® (available from PayPal Holdings, Inc. of San Jose, Calif.), and the like. Payment may be made regarding a certain time frame (such as, without limitation, per minute), per session, and/or as part of a subscription in which user 702 gets limited or unlimited consultation access during the time of the subscription. Such subscription may comprise any appropriate time period, including one month, one year, and the like. Process 1300 then proceeds to step 1322.

At step 1322, infrastructure 701 determines that user 702 has stopped the consult session. This may be the result of user 702 choice or upon the expiration of time for the consult session. If it is the result of user 702 choice, user 702 may use user control device 704 to indicate to infrastructure 701 that user 702 is done with the consult session. Such an indication may be made by user 702 interacting with user control device 704, such as by interacting with a graphical user interface upon a display screen (e.g., by using a mouse-click or finger tap to press a virtual button), by engaging a physical element associated with user control device 704 (e.g., by pressing a button on a keyboard, engaging a switch, etc.), by stating a verbal command to be received by one or more microphones associated with user control device 704, by gesturing (e.g., by making a motion interpreted by a camera upon user control device 704, by moving user control device 704 a certain way to engage an internal accelerometer, etc.), or by any other appropriate means as may be apparent to those skilled in the relevant art(s) after reading the description herein. If the consult session time expires before user 702 indicates a choice to stop it, then infrastructure 701 may intervene by cutting off the communication connection between user 702 and the consultant, such as, by way of example and not limitation, via cancelling the connection between user 702 user control device 704 and the consultant's user control device 704. Process 1300 then proceeds to step 1324.

At step 1324, the consultation session is terminated. All communication links between user 702′s and the consultant's user control device(s) 704 are closed, if applicable. Additionally, in some aspects, user 702 may log out of the user application associated with infrastructure 701.

Process 1300 then terminates at step 1326.

It is noted that, as has been previously stated, processes 800-1300 may function with or without enclosing apparatus 100. In aspects wherein processes 800-1300 function with the use of enclosing apparatus 100, some or all of the functions performed by infrastructure 701 may be performed by apparatus computing device 736.

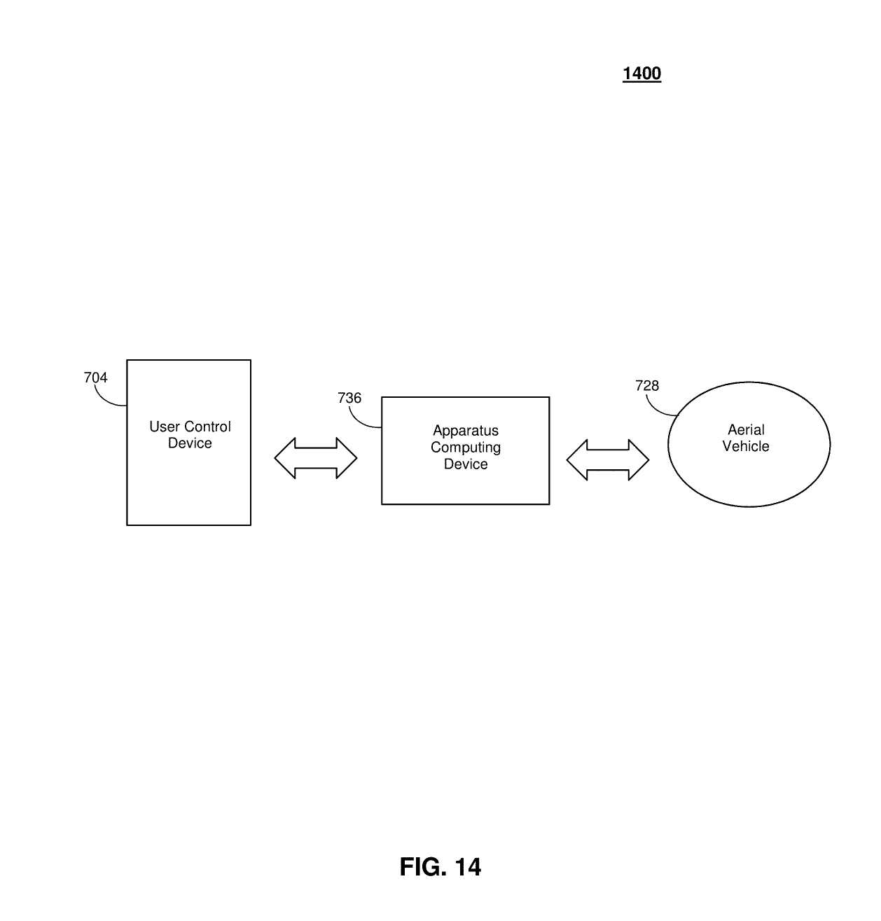

Referring now to FIG. 14, a dataflow diagram 1400 of an exemplary communication process for exemplary system 700 for facilitating electronic communication of information between different components associated with exemplary enclosing apparatus 100, according to an aspect of the present disclosure, is shown.

In aspects wherein aerial vehicle 728 rentals, purchases, sales, consultations, and/or aerial vehicle 728 competitions/games take place within enclosing apparatus 100, electronic communication of information and/or data may take place among three main components, those being user control device 704, apparatus computing device 736, and aerial vehicle 728. As has been previously discussed, user control device 704 may be used to directly control aerial vehicle 728. User control device 704 may also be used to communicate with apparatus computing device 736 for a variety of purposes, including facilitating rentals, purchases, and/or sales of aerial vehicles 728; facilitating engagement in aerial vehicle 728 consultations; and establishing competitions/games for aerial vehicles 728 within flight zone 102 of enclosing apparatus 100. Apparatus computing device 736 then, in turn, may need to communicate with aerial vehicles 728 within enclosing apparatus 100 in order to regulate access to and monitor information regarding aerial vehicles 728 that are available for rent or purchase, or that require consulting services; as well as monitor the location and usage of those aerial vehicles 728. Additionally, apparatus computing device 736 may be used to regulate aerial vehicle 728 competitions/games by, amongst other things, keeping score, tracking statistics, regulating start and stop times, relaying information to user control device(s) 704 of participating users 702, and the like.

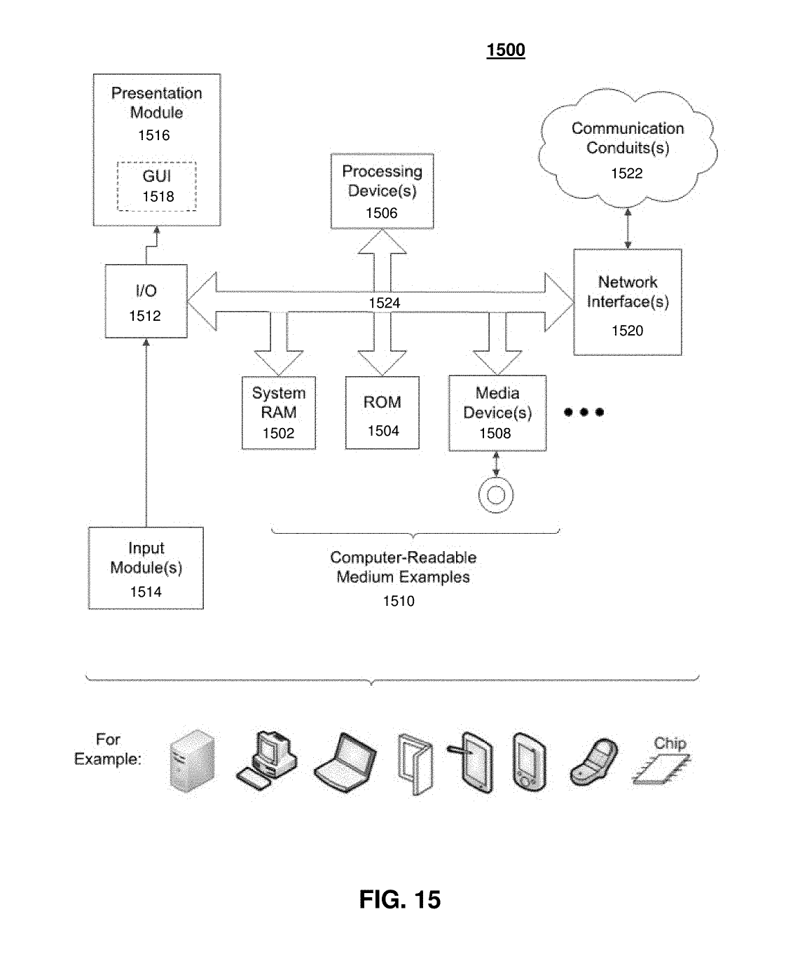

Referring now to FIG. 15, a block diagram of an exemplary computer system useful for implementing one or more aspects of the present disclosure, is shown.

FIG. 15 sets forth an illustrative computer system that may be used to implement computing functionality 1500, which in all cases represents one or more physical and tangible processing mechanisms.

Computing functionality 1500 may comprise volatile and non-volatile memory, such as RAM 1502 and ROM 1504, as well as one or more processing devices 1506 (e.g., one or more central processing units (CPUs), one or more graphical processing units (GPUs), and the like). Computing functionality 1500 also optionally comprises various media devices 1508, such as a hard disk module, an optical disk module, and so forth. Computing functionality 1500 may perform various operations identified above when the processing device(s) 1506 execute(s) instructions that are maintained by memory (e.g., RAM 1502, ROM 1504, and the like).

More generally, instructions and other information may be stored on any computer readable medium 1510, including, but not limited to, static memory storage devices, magnetic storage devices, and optical storage devices. The term “computer readable medium” also encompasses plural storage devices. In all cases, computer readable medium 1510 represents some form of physical and tangible entity. By way of example and not limitation, computer readable medium 1510 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 1502, ROM 1504, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 1500 may also comprise an input/output module 1512 for receiving various inputs (via input modules 1514), and for providing various outputs (via one or more output modules). One particular output module mechanism may be a presentation module 1516 and an associated GUI 1518. Computing functionality 1500 may also include one or more network interfaces 1520 for exchanging data with other devices via one or more communication conduits 1522. In some aspects, one or more communication buses 1524 communicatively couple the above-described components together.

Communication conduit(s) 1522 may be implemented in any manner (e.g., by a local area network, a wide area network (e.g., the Internet), and the like, or any combination thereof). Communication conduit(s) 1522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “service,” “module,” and “component” as used herein generally represent software, firmware, hardware, or any combination thereof. In the case of a software implementation, the service, module, or component represents program code that performs specified tasks when executed on one or more processors. The program code may be stored in one or more computer readable memory devices, as described with reference to FIG. 12. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming consoled, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., utilization with different support structures; utilization of different configurations and materials other than those mentioned herein). As will be appreciated by those skilled in the relevant art(s) after reading the description herein, certain features from different aspects of the apparatus and components of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. An enclosing apparatus configured to confine at least one aerial vehicle within an at least partially contained flight zone, the enclosing apparatus comprising:
at least one containment boundary at least partially encompassing the at least partially contained flight zone, and
at least one user area comprising at least one view of the interior portion of the at least partially contained flight zone;
wherein the at least one user area is configured in a location comprising at least one of: a location within the enclosing apparatus protected from the at least one aerial vehicle flown within the at least partially contained flight zone; a location outside of but physically connected to the enclosing apparatus; and a location detached from the enclosing apparatus; and
wherein the at least one view of the interior portion of the at least partially contained flight zone is achieved by at least one of: direct human eyesight and electronically assisted viewing.

2. The enclosing apparatus of claim 1, wherein the at least one aerial vehicle comprises an unmanned aerial vehicle.

3. The enclosing apparatus of claim 1, wherein the at least partially contained flight zone comprises at least one of: a portion of Earth's atmosphere and an extraterrestrial environment.

4. The enclosing apparatus of claim 1, wherein the at least one containment boundary comprises at least one of: at least one physical component and at least one electrical component.

5. The enclosing apparatus of claim 4, wherein the at least one physical component comprises at least one of: netting material, canvas, cloth, rubber, foam, latex, leather, and plastic.

6. The enclosing apparatus of claim 4, wherein the at least one electrical component comprises at least one of: an infrared signal, a radio frequency signal, a Bluetooth® signal, and an acoustic signal.

7. The enclosing apparatus of claim 4, wherein the enclosing apparatus further comprises at least one support structure configured to support at least one of: the at least one physical component of the at least one containment boundary and the at least one electrical component of the at least one containment boundary.

8. The enclosing apparatus of claim 7, wherein the at least one support structure comprises:
a bottom circular portion,
a top circular portion, and
at least one sidewall component securely connecting the bottom circular portion to the top circular portion.

9. The enclosing apparatus of claim 8, wherein the top circular portion of the at least one support structure comprises at least one cross sectional support segment substantially parallel to the top circular portion and at least one downwardly projecting support pole; and
wherein the at least one sidewall component comprises at least one support rod protruding toward an inner portion of the at least one support structure.

10. The enclosing apparatus of claim 9, wherein the at least one support segment, the at least one support pole, and the at least one support rod each comprise at least one connection mechanism configured to securely or movably receive a portion of the at least one physical component of the at least one containment boundary.

11. The enclosing apparatus of claim 10, wherein the at least one connection mechanism comprises at least one of: a cable tie, a clip, a clamp, a clasp, a hook, a zipper, a snap, a pin, a hook-and-loop fastener, a rope knot, a suction cup, and an adhesive.

12. The enclosing apparatus of claim 7, wherein the at least one support structure comprises:
at least one support post, and
at least one support connector;
wherein the at least one support connector is configured to securely or movably attach to the at least one support post at a first distal end and securely or movably attach to a portion of the at least one physical component of the at least one containment boundary at a second distal end.

13. The enclosing apparatus of claim 12, wherein the at least one support connector comprises an at least partially flexible member comprising at least one of: a cable, a rope, and a cord.

14. The enclosing apparatus of claim 12, wherein the at least one support connector comprises a substantially rigid member comprising at least one of: a rod and a hook.

15. The enclosing apparatus of claim 12, wherein the first distal end and the second distal end each comprise at least one connecting element, whereon the at least one connecting element comprises at least one of: a cable tie, a clip, a clamp, a clasp, a hook, a zipper, a snap, a pin, a hook-and-loop fastener, a suction cup, a welded bond, a rope knot, and an adhesive.

16. The enclosing apparatus of claim 1, wherein the enclosing apparatus further comprises at least one obstacle about which aerial vehicles are flown around.

17. The enclosing apparatus of claim 16, wherein the at least one obstacle comprises at least one of: a ring, a loop, a solid geometric structure and an electrical signal.

18. The enclosing apparatus of claim 4, wherein the at least one physical component of the at least one containment boundary is configured to be substantially void of hard edges and corners.

19. The enclosing apparatus of claim 18, wherein the vertical cross section of the at least one physical component of the at least one containment boundary comprises a substantially parabolic shape.

20. The enclosing apparatus of claim 1, wherein the electronically assisted viewing is facilitated by at least one electronically assisted viewing component.

21. The enclosing apparatus of claim 20, wherein the at least one electronically assisted viewing component comprises at least one of: a camera, a display screen, a computing device, and a motion detector.

22. The enclosing apparatus of claim 1, the enclosing apparatus further comprising at least one aerial vehicle monitoring component configured to capture aerial vehicle performance information.

23. The enclosing apparatus of claim 22, wherein the at least one aerial vehicle monitoring component comprises at least one of: a sensor, a motion detector, a camera, and a laser.

24. The enclosing apparatus of claim 22, wherein the aerial vehicle performance information comprises at least one of: an aerial vehicle location, an aerial vehicle speed measurement, an aerial vehicle agility measurement, and an aerial vehicle proximity measurement to other objects.

25. The enclosing apparatus of claim 22, wherein at least a portion of the aerial vehicle performance information is displayed on at least one of: a user computing device, a user area display screen, and a user area scoreboard.

26. The enclosing apparatus of claim 7, wherein the at least one support structure is integrated with at least one of: at least one aerial vehicle monitoring component configured to capture aerial vehicle performance information and at least one electronically assisted viewing component configured to facilitate the electronically assisted viewing.

27. The enclosing apparatus of claim 1, wherein the location detached from the enclosing apparatus comprises at least one of: a building interior, an outdoor area, and a building rooftop.

28. The enclosing apparatus of claim 4, wherein the at least one containment boundary at least partially comprises the at least one electrical component.

29. The enclosing apparatus of claim 28, wherein the at least one electrical component comprises at least one of: an infrared signal, a radio frequency signal, a Bluetooth® signal, and an acoustic signal.
